(19) United States
(12) Patent Application Publication
(10) Pub. No.: US 2017/0071245 A1
(43) Pub. Date: Mar. 16, 2017

(54) CITRUS FRUIT PRESSING DEVICE AND METHOD FOR PRESSING JUICE FROM A PIECE OF CITRUS FRUIT

(71) Applicant: KONINKLIJKE PHILIPS N.V., EINDHOVEN (NL)

(72) Inventors: THEODOOR STOLK, EINDHOVEN (NL); MARJAN WILLEKE ESTHER CORNELISSEN, EINDHOVEN (NL); WILLIAM JOHANN NIKOLAUS UNTEREGGER, EINDHOVEN (NL); GERTRUDE RIËTTE VAN DER KAMP, EINDHOVEN (NL); KLAAS KOOIJKER, EINDHOVEN (NL)

(21) Appl. No.: 15/310,957

(22) PCT Filed: May 5, 2015
(86) PCT No.: PCT/IB2015/053265

§ 371 Date: Nov. 14, 2016

Related U.S. Application Data
(60) Provisional application No. 61/992,443, filed on May 13, 2014.

(51) Int. Cl. A23N 1/00; A47J 19/02; A23N 1/02

(52) U.S. Cl. CPC A23N 1/003; A23N 1/02; A47J 19/02

(57) ABSTRACT

Citrus fruit pressing devices, apparatus and methods are disclosed. Several features that can reduce the incidence of rupturing oil pockets in the fruit peel can be employed to improve the taste of the juice pressed from the fruit. One feature includes cutting (307) the peel at least partly along a circumference of the fruit to reduce rupturing of oil pockets when the fruit is flattened and the surface of the fruit is folded over. Another feature includes utilizing a curved knife, which can provide a relatively deep cut and a smooth expansion of the peel. According to other aspects, juice extraction can be improved by employing one or more protrusions in a surface of the pressing element to press areas of the fruit in which the peel of the fruit is not present. Another aspect is directed to using the pressing speed to control the pulp content of the juice.

### FIELD OF THE INVENTION

The present invention is directed generally to juicers and, more particularly, to citrus fruit pressing apparatus, devices and methods.

### BACKGROUND OF THE INVENTION

Well-known examples of citrus fruit are oranges, lemons, limes and grapefruit. Citrus fruit is eaten fresh, pressed for juice, or preserved in marmalades, for example. The present invention provides solutions in the field of pressing juice from citrus fruit. Various types of citrus fruit pressing devices are known, wherein the devices range from hand-operated devices comprising a convex pressing surface surrounded by a channel for receiving juice from pre-cut halve pieces of citrus fruit to fully automated devices which are adapted to extract juice from citrus fruit without human intervention.

Pressing citrus fruit by hand is a rather bothersome job. An additional disadvantage of the process is that it is practically impossible for a user of the hand-operated device to keep his/her hands clean. Also, the device which is used in the process is quite difficult to clean, particularly a ring-shaped sieve which is part of the device and which is used for covering the channel and receiving pulp. It is a fact that juice from citrus fruits, especially orange juice, is very much appreciated by consumers. Orange juice has a sweet taste and is known for being healthy, as it contains a considerable quantity of vitamin C. However, due to the disadvantages as mentioned, people often decide to refrain from making the juice when they actually would like to do so, especially when there is not too much time, which may be the case at breakfast time in the morning during working days, for example.

In order to facilitate the task of pressing halve pieces of citrus fruit on the pressing surface, semi-automated citrus fruit pressing devices have been developed. In such devices, an element comprising the pressing surface is automatically rotated when a user presses down a halve piece of citrus fruit on the element. As a result, making juice from citrus fruit requires less effort from a user, but a user is still compelled to perform various actions, including extensive cleaning actions after use of a semi-automated device.

Fully automated devices are adapted to process whole pieces of citrus fruit. In particular, the devices are adapted to cut the pieces of citrus fruit in half, press the halve pieces of citrus fruit against a pressing surface, collect the juice which is obtained in this way, and discharge the juice to a receptacle, such as a glass. Fully automated devices are very easy to use, but they are not suitable for domestic use due to their large size. Also, the devices comprise a lot of parts and require a lot of work when it comes to cleaning. An example of fully automated devices is found in GB 2 216 784 A.

A device which is adapted to perform an automatic pressing action on citrus fruit and which can be small enough for being used in a normal kitchen is known from WO 2012/107771 A1. Among other things, the known device comprises a press means, an infeed means, a waste receptacle and a motor. The press means includes two portions, namely a ram portion and an extracting portion located a spaced distance apart from each other inside a housing of the device. The ram portion and the extracting portion are located along the same axis, so that pressing one or more articles inside the device can be realized by positioning the articles between the ram portion and the extracting portion and moving the ram portion towards the extracting portion.

The movement of the ram portion is driven by the electric motor which is also located inside the housing. The extracting portion includes a blade means for cutting the article to provide an outlet for the juice and a channel to transport the juice away from the pressed article. The force of the press means typically expels the juice from the article. A number of blade means may be provided in order to have a number of channels.

### SUMMARY OF THE INVENTION

Pressing whole pieces of citrus fruit in a relatively small device would not be so much of a challenge if it was not for the fact that the peel of the citrus fruit contains oil which should not be mixed with the juice, as the oil ruins the sweet taste of the juice. Although the device known from WO 2012/107771 A1 appears to function in practice, it has been found that oil is often released from the peel in such quantity that the taste of the juice is not acceptable. A reason for this effect is found in the fact that at a certain stage of a pressing action, the peel which is punctured by the blade means rips at various places close to the blade means due to the deformation of the piece of citrus fruit and the forces acting on the peel, as a result of which oil is released, which mixes with the juice and is discharged through the blade means along with the juice.

One exemplary aspect of the present disclosure is directed to providing a citrus fruit pressing device which is easy to use and easy to clean and which is capable of reliably yielding juice with a sweet taste as desired by reducing the amount of peel oil that is mixed with the juice. The device should be of a relatively simple yet robust design that is small enough to be used on a normal kitchen top. These aspects can be achieved by means of a citrus fruit pressing device, comprising: two pressing elements for performing a pressing action on a piece of citrus fruit, which pressing elements have surfaces for contacting different sides of a piece of citrus fruit to be pressed, and which pressing elements are movable with respect to each other in two opposite directions, i.e. towards each other and away from each other, and cutting means for performing a cutting action on a piece of citrus fruit, through the peel of the piece, which cutting means are arranged for penetrating into the piece from a side which is free from contact to the surfaces of the pressing elements.

In a device according to an exemplary aspect, the surfaces of the pressing elements as mentioned are designed to be used for exerting a pressing force on a whole piece of citrus fruit. For that reason, the surfaces will hereinafter be referred to as pressing surfaces. According to one exemplary feature, pieces of citrus fruit to be pressed are cut at a position which is not only at the pressing surfaces, or not at all at the pressing surfaces. In particular, the cutting means of the device can be arranged for penetrating into a piece of citrus fruit from a side which is free from contact to the pressing surfaces. In other words, the cutting means can be arranged to form a cutting action alongside a pressing movement of the pressing surfaces with respect to each other.

The cutting action of the cutting means on a piece of citrus fruit can be automatically performed when the piece is pressed between the pressing surfaces, as the knife can be located in an area where the piece expands in a sideward direction as a result of a pressing action. An advantage of the location of the cutting means as mentioned is that a defined cut can be made in a piece of citrus fruit on the one hand, while the chance that ripping of the peel takes place at some point during a pressing action can be minimized. The peel need not be weakened at the location of contact to the pressing surfaces, but at the side where large deformations can be expected during a pressing action. Moreover, having cutting means outside of the pressing surfaces offers a possibility of collecting the juice directly from at least one cut in a piece of citrus fruit, wherein there is no need for a complex construction for making channels through one of the pressing surfaces as known from WO 2012/107771 A1.

It is advantageous to press juice from whole pieces of citrus fruit, wherein at least one knife is used to penetrate the pieces, through the peel. In this respect, it is noted that the pieces of citrus fruit do not need to be cut in a number of separate portions, so that it is sufficient for the knife to only penetrate the pieces. As mentioned in the foregoing, the peel contains oil which can spoil the taste of the juice. However, is has been found that when a defined cut is made through the peel, only a minimum quantity of oil is released, with no notable influence on the taste of the juice, contrary to a quantity of oil which is released when the peel rips. Hence, if measures are taken for avoiding tearing or ripping of the peel, most or all of the juice only passes the peel at a location of a defined cut, so that pressing actions can be successful in that sweet juice is obtained.

In respect of pressing whole pieces of citrus fruit, it is noted that a general advantage of such a process is that pulp can be kept inside the pieces, so that there is no need for the pressing device to comprise dedicated means for receiving pulp, which adds to simplicity of design.

In one exemplary embodiment, the device comprises a generally cylinder-shaped pressing chamber having an interior space for receiving a piece of citrus fruit to be pressed, which pressing chamber is partially delimited by the pressing surfaces, wherein one pressing surface constitutes one end surface of the pressing chamber, wherein another pressing surface comprises an opposite end surface of the pressing chamber, and wherein the cutting means comprise at least one knife which is arranged inside the pressing chamber on a side surface of the pressing chamber.

Preferably, the cutting means are located at a side of the pressing chamber which is a bottom side in an operational orientation of the device. For example, the cutting means may comprise two knives which are arranged in a lower half of the pressing chamber. In this way, a piece of citrus fruit can be cut at its bottom side, so that when the pressing action takes place, juice which is squeezed from the piece is directly or almost directly in a position for dripping from the orange, so that the extent to which the juice is allowed to contact the peel is minimal. Furthermore, juice can simply be received at the bottom side of the pressing chamber, as a result of which there is no need for complex means for discharging the juice from the pressing chamber.

It is possible for the at least one knife of the cutting means to comprise a straight cutting blade. It has been found that by making one, two or three straight cuts through the peel and a portion of the pulp of the piece of citrus fruit which is present behind the peel, with a length of half the periphery of the piece, for example, it is possible to press the piece to such an extent that a maximum quantity of juice is obtained without ripping the skin during the deformation of the piece. In a practical situation, two straight cuts can be made in a lower half of a piece of citrus fruit as arranged inside the pressing space, wherein the cuts are at different positions along the periphery of the piece. It is noted that the knife may have a constant height along its length. However, this is not necessary, as it may also be that a cutting edge of the knife has an inclined orientation with respect to a base of the knife. The knife can have any design which is adapted to realize a cut in a piece of citrus fruit of desired shape and dimensions. For example, the knife may comprise two portions, wherein cutting edges of the portions are perpendicular with respect to each other, whereby a deep cut can be realized. In such an embodiment of the knife, one of the portions of the knife may be arranged on one of the pressing surfaces.

The cutting blade of the knife may extend in a direction which is substantially the same as the directions in which the pressing elements are movable with respect to each other. In that way, it is ensured that at least one cut is made in a piece of citrus fruit as it is pressed between the pressing surfaces which is capable of releasing the pressure in the peel in such a way that ripping of the peel is avoided. The cut is effective in doing so when the cut extends in the direction in which the pressing action is performed. Hence, on the basis of the presence of the cut in the peel, a situation in which the elasticity of the peel is exceeded is avoided, so that ripping of the peel is avoided. If the peel rips in practical cases, it is likely that this only happens near the end of the pressing action, when most or all the juice has already been squeezed from the piece of citrus fruit. Hence, the amount oil released from the peel can be reduced due to the fact that any such ripping occurs at a late stage of a pressing action.

It is noted that in a practical case, the directions in which the pressing elements are movable with respect to each other can coincide with a direction in which a longitudinal axis of the cylinder shape of the pressing chamber extends. The pressing chamber may be shaped like a straight cylinder having a circular periphery, wherein a diameter of the cylinder is adapted to a general diameter of the pieces of citrus fruit to be pressed, and wherein a length of the cylinder is also adapted to the general diameter of the pieces of citrus fruit to be pressed, so that the pressing chamber is capable of freely receiving the pieces of citrus fruit prior to a pressing action. At the start of a pressing action, a distance between the opposite end surfaces of the pressing chamber is at a maximum, whereas at the end of a pressing action, the distance as mentioned is considerably smaller. At least one of the pressing elements may comprise at least one recess for allowing the pressing element to move over the knife, so that the mutual movement of the pressing elements is not hindered by the presence of the knife, while there is no need for relatively complex measures such as measures aimed at retracting the knife at a certain point.

It is practical if a position of one of the pressing elements is fixed in the directions in which the pressing elements are movable with respect to each other, wherein the surface on which the at least one knife of the cutting means is arranged is part of that one of the pressing elements. In such a case, the relative movement of the pressing surfaces which is used for performing a pressing action on a piece of citrus fruit is realized by moving only one pressing element, which is less complex than having two movably arranged pressing elements and moving both pressing elements.

In order to have automated functioning of the citrus fruit pressing device, the device can comprise driving means for engaging with at least one of the pressing elements and moving the at least one of the pressing elements in the directions for changing the size of a space as present between the pressing elements when being activated. For example, the driving means may comprise an electromotor and means such as a spindle drive for connecting the at least one of the pressing elements to an outgoing shaft of the motor.

One of the pressing elements may have an opening for allowing a piece of citrus fruit to pass from outside the pressing element to inside the pressing element, i.e. inside the pressing chamber, and vice versa, wherein the pressing element may furthermore be rotatably arranged in the device. In a practical example, the opening in the pressing element concerned is located in such a way as to provide access to the pressing chamber in a direction which is more or less perpendicular to the directions in which the pressing surfaces are movable with respect to each other. In particular, it is advantageous if the pressing element is rotatable about an axis extending in a direction which is substantially the same as the directions in which the pressing elements are movable with respect to each other. Preferably, in case a position of one of the pressing elements is fixed in the directions in which the pressing elements are movable with respect to each other, as mentioned in the foregoing, one of the pressing elements is also the one of the pressing elements which has an opening for receiving a piece of citrus fruit and which is rotatably arranged in the device.

Suitable feeding means, such as, for example, a feeding tube for feeding a piece of citrus fruit to the pressing chamber through the opening in the pressing element, may be arranged at a level above the pressing chamber so that supply of pieces of citrus fruit can simply take place under the influence of gravity. With a rotatable arrangement of the pressing element, it is possible to have a first position of the pressing element in which the opening is at the end of the feeding means, so that a piece of citrus fruit is allowed to fall into the pressing chamber, and a second position of the pressing element in which the opening is at a bottom side, so that a piece of citrus fruit which has been subjected to a pressing action is allowed to exit the pressing chamber under the influence of gravity. Optionally, it is also possible to rotate the pressing element along a short angular distance after a piece of citrus fruit to be pressed has been supplied to the pressing chamber, in order to prevent another piece of citrus fruit from passing through the opening and entering the pressing chamber as well. Another option is to have separate means at the opening for blocking and unblocking the opening.

In case the citrus fruit pressing device according to the present invention is equipped with a rotatably arranged pressing element as mentioned, it is preferred to have separate driving means for engaging with the pressing element and rotating the pressing element when being activated. These separate driving means may comprise a low power electromotor, as hardly any force is involved in rotating the pressing element compared to the forces needed in a pressing action. Hence, costs of the separate driving means can be relatively low.

In order to promote discharge of juice from the pressing chamber, it is advantageous if a surface of the pressing chamber which is at a side of the pressing chamber which is a bottom side in an operational orientation of the device has an inclined orientation with respect to the horizontal in the operational orientation of the device. In that case, the juice automatically flows to a defined location of the pressing chamber under the influence of gravity. Needless to say that it is most practical for the pressing chamber to be provided with a discharge opening at that location.

In order to limit the extent to which the peel of a piece of citrus fruit is deformed during a pressing action, one exemplary embodiment includes pressing surfaces that have complementary curved shapes. Advantageously, one of the pressing surfaces has a generally concave shape, whereas another of the pressing surfaces has a generally convex shape. The shapes of the pressing surfaces are another factor in avoiding ripping of the peel of a piece of citrus fruit during a pressing action.

In one embodiment, the device includes one pressing surface with a generally convex shape as mentioned and a concave central portion, and includes another pressing surface with a generally concave shape as mentioned and a convex central portion. In this way, the curvature of the surfaces is flipped in the center, which helps in preventing thick peels from ripping, as a large curve length difference between two sides of a piece of citrus fruit to be pressed is prevented.

In accordance with other exemplary aspects of the invention, the extraction of juice can be further improved in a variety of ways, while at the same time reducing oils released by the peel that can taint the taste of the juice. For example, according to one aspect, one or more knives employed to cut into the peel can include a curved edge. The edge can include a first edge portion that is substantially parallel to an axis along which the pressing elements move and a second edge portion that is substantially perpendicular to the axis. The use of the curved edge can cut relatively deep and reduce tearing of the peel. In particular, when a plurality of knives are used, the curved edges can flatten a piece of the peel between the knives and enable the periphery of the peel to expand out smoothly, thereby reducing the incidence of tearing.

According to another exemplary aspect, the extraction of the juice can be improved by employing protrusions in one or more of the pressing elements. For example, at least two knives that are separated by a separation space can be used to cut the peel of a citrus fruit. When the peel expands out peripherally, the peel leaves a space in which no peel is present between cut edges of the peel. As such, if the pressing elements are relatively flat, any pulp expelled in this space would not be completely pressed. Thus, a surface of the protrusion can be delineated by the outside surface of one the knives, opposing the surface of the knife in the separation space, to ensure that the protrusion is disposed in the space between the cut edges of the peel. As a result, the protrusion can press any pulp that expands in this area to improve the extraction of juice from the fruit. In one embodiment, the protrusion can follow and match the shape of the knife, the pressing housing and the peel edge to cover the space between the peel edges. Preferably, in one embodiment, the peel covers at least 75% of the area between cut edges of the peel. In accordance with various embodiments, one of the pressing elements can include a plurality of such protrusions on the outside of a plurality of the knives and/or both of the pressing elements can include protrusions to press pulp in the space between cut edges of the peel.

Another exemplary aspect of the invention is directed to further reducing rupturing of oil pockets in a peel of a citrus fruit that can degrade the taste of the juice. For example, when a citrus fruit is pressed between two pressing elements, the peel folds over when the fruit is flattened. Due to the pressure imposed on the peel, the oil pockets at the folds rupture and release bitter-tasting oil into the juice. Thus, to reduce the incidence of this type of rupturing, one exemplary aspect employs a cutting element to form a cut into a peel of the citrus fruit at least partly along a circumference of the citrus fruit. Here, the device is configured to press the citrus fruit such that an outer surface of the citrus fruit is folded along the cut. As such, the pressing element can press, flatten and fold over the peel/surface of the fruit with minimal rupturing of the pockets and release of the oil near the cut, as the cut ensures that a relatively low pressure is applied to the peel near the fold. In one embodiment, the cut can be implemented as a hinge cut in that the depth of the cut penetrates less than the thickness of the peel. This feature can aid in reducing the amount of juice that passes through this cut, ensuring that any oil released due to the cut minimally intermingles with juice pressed out of the fruit. Furthermore, the feature can also reduce the amount of pulp expelled at the cut, rendering it easier to keep the chamber clean and easier to expel the pulp and peel from the chamber.

While the at least partly circumferential cut can be effective in reducing rupturing of oil pockets in the peel, when the fruit is dropped into a pressing chamber, it can be difficult to maintain the orientation of the fruit so that the surface of the fruit is folded at the cut when the fruit is pressed. This is especially the case if the pressing chamber is disposed at an incline. Accordingly, in one embodiment, the cut can be implemented outside of the pressing chamber to perform a precise cut and flaps can be employed at the opening of the pressing chamber to reduce the velocity of the fruit as it enters the chamber. The slowing of the fruit in this way reduces the bounce of the fruit within the chamber, thereby aiding in maintaining the orientation. In one version of the embodiment, gripping extensions can be employed on an outer surface of a pressing housing. Here, the pressing housing is configured to rotate and the gripping extensions are configured to grip and turn the fruit as it is cut by the cutting element.

In an alternative embodiment of the present invention, the peel is cut at least partly along a circumference of the fruit within the pressing chamber to aid in ensuring that the fruit is at an orientation that enables the pressing elements to fold over the surface of the fruit along the cut. Cutting the fruit in this way within the chamber permits the device to better accommodate different sizes of fruits. In one version of the embodiment, the cut can be implemented through oscillating, rotational motion of the pressing housing to move the fruit along the cutting element. In another version of the embodiment, the cut can be implemented by rotating a rotatable member within the housing to move the fruit along the cutting element. In accordance with one particular feature, the cutting element can be disposed between the primary cutting element and one of the surfaces of the pressing elements such that the at least partly circumferential cut is implemented after the primary cut through which juice is extracted from the fruit. This feature facilitates dropping the pulp and peel out of the pressing chamber, as the fruit can pass the primary knives completely and is less likely to be caught on the primary knives.

Another aspect is directed to a method for pressing juice from a citrus fruit. In accordance with the method, the citrus fruit is received through an opening to a pressing chamber, where ends of the pressing chamber are defined by surfaces of pressing elements. The method further includes cutting into a peel of the citrus fruit at least partly along a circumference of the citrus fruit and pressing the citrus fruit such that an outer surface of the citrus fruit is folded along the cut. As discussed above, this feature reduces the incidence of rupturing of oil pockets in the peel when the fruit is flattened by the pressing elements.

In accordance with another aspect, the pulp content can be controlled by adjusting the relative speed at which the fruit is pressed. For example, it has been found that the pulp content in the juice is dependent on the speed at which the fruit is pressed. One exemplary method of the present invention includes receiving a pulp content selection from a user. Here, the citrus fruit can be received through an opening to a pressing chamber, where ends of the pressing chamber are defined by surfaces of pressing elements. Further, the fruit can be pressed and cut by contacting different sides of the citrus fruit with the surfaces and implementing relative motion of the pressing elements at a pressing speed that is determined based on the pulp content selection. The pulp and the peel of the citrus fruit can be expelled out of the pressing chamber by rotating the chamber and enabling the pulp and the peel to fall out of the opening due to gravity. In accordance with one embodiment, the pressing speed is determined based on a function correlating pressing speeds to pulp content selections, where the pressing speeds increase with increasing pulp content. In addition, the pulp content can be adjusted while the fruit is pressed. For example, a second pulp content selection can be received from a user and the citrus fruit can be pressed and cut by adjusting the pressing speed of the relative motion.

The above-described and other aspects of the present invention will be apparent from and elucidated with reference to the following detailed description of exemplary embodiments of pressing devices, apparatus and methods, which are especially suitable for pressing oranges, and components of the devices and apparatus and their functions.

### BRIEF DESCRIPTION OF THE DRAWINGS

Exemplary embodiments of the present invention will now be explained in greater detail with reference to the figures, in which like reference characters generally refer to the same parts throughout the different views, and in which:

FIG. 1 is a diagram of a perspective view of a pressing device according to one embodiment in an operational orientation in which a number of oranges are present in a holder on top of the device and a glass is positioned at an outlet of the device;

FIG. 2 is a diagram of a perspective view of the pressing device of FIG. 1 with a lid of the pressing device in an opened position;

FIG. 3 is a diagram of a perspective view of an interior of the pressing device of FIG. 1 from a top side, depicting two pressing elements that are present in the interior of the pressing device;

FIG. 4 is a diagram of a perspective view of the interior of the pressing device as shown in FIG. 3, with the pressing elements removed;

FIG. 5 is a diagram of a side view of one of the pressing elements of FIG. 1;

FIG. 6 is a diagram of a perspective view of another of the pressing elements of FIG. 1;

FIG. 7 is a diagram of a number of components of the pressing device of FIG. 1, particularly the pressing elements and means for driving one of the pressing elements;

FIG. 8 is a diagram of a sectional view of the components of the pressing device depicted in FIG. 7;

FIG. 9 is a diagram of a sectional view of complementary curved surfaces of the pressing elements in accordance with an exemplary embodiment;

FIG. 10 is a diagram of an orange depicting oil pockets within the peel of the orange;

FIG. 11 is a diagram of exemplary knives that can be used as primary cutting elements in accordance with exemplary embodiments;

FIG. 12 provides diagrams of a peel cut by a pressing device in accordance with an exemplary embodiment and protrusions in one or more pressing surfaces in accordance with an exemplary embodiment;

FIG. 13 provides diagrams of cross-sectional views of pressing surfaces including protrusions in accordance with exemplary embodiments;

FIG. 14 is a diagram of a pressing surface including protrusions in accordance with an exemplary embodiment;

FIG. 15 is a diagram of an alternate view of the pressing surface of FIG. 14;

FIG. 16 provides a diagram illustrating a pressed citrus fruit, and a diagram illustrating a hinged circumferential cut in the citrus fruit in accordance with an exemplary embodiment;

FIG. 17 is a diagram illustrating the position of a circumferential cut of a citrus fruit in accordance with an exemplary embodiment;

FIG. 18 provides a diagram illustrating a circumferential removal of a peel of a citrus fruit in accordance with an exemplary embodiment;

FIG. 19 provides several alternatives for implementing circumferential cuts and/or for removing a peel or a portion of a peel of a citrus fruit in accordance with exemplary embodiments;

FIG. 20 is a diagram of a portion of a pressing device in which a circumferential cut is implemented outside of a pressing chamber in accordance with an exemplary embodiment;

FIG. 21 is a diagram of a pressing device in which a circumferential cut is implemented outside of a pressing chamber and in which flaps are employed to reduce the velocity of a citrus fruit when it is transferred into the pressing chamber in accordance with an exemplary embodiment;

FIG. 22 is a diagram of a cross-sectional view of the pressing device of FIG. 21;

FIG. 23 is a diagram of exemplary flaps that can be employed in a pressing device in which a circumferential cut is implemented outside of a pressing chamber in accordance with an exemplary embodiment;

FIG. 24 is a diagram of a pressing device in which a circumferential cut is implemented inside a pressing chamber in accordance with an exemplary embodiment;

FIG. 25 is a diagram of a cross-sectional view of the device of FIG. 24;

FIG. 26 is a diagram of an alternate cross-sectional view of the device of FIG. 24;

FIG. 27 is a diagram of a pressing device in which a circumferential cut is implemented inside a pressing chamber after primary cuts for extracting juice are performed in accordance with an exemplary embodiment;

FIG. 28 is a diagram of a cross-sectional view of the device of FIG. 27;

FIG. 29 is a diagram of an alternate cross-sectional view of the device of FIG. 27;

FIG. 30 is a block/flow diagram of a method for pressing juice from a citrus fruit in accordance with exemplary embodiments;

FIG. 31 is a diagram illustrating a relationship between the pressing speed of a pressing device and pulp content of juice extracted by the pressing device; and

FIG. 32 is a block/flow diagram of a method for pressing juice in which pulp content of the juice can be adjusted.

### DETAILED DESCRIPTION OF EMBODIMENTS

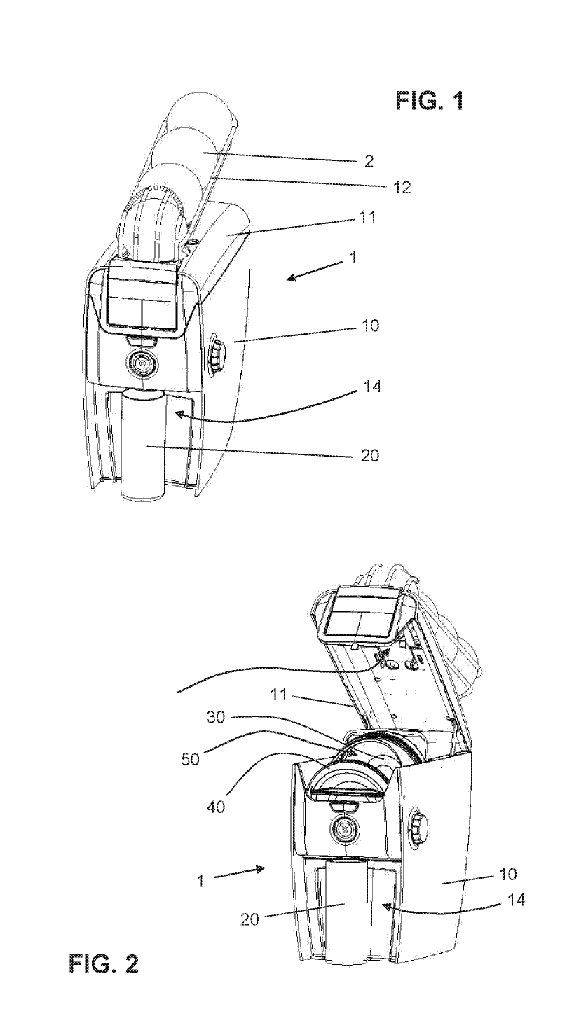

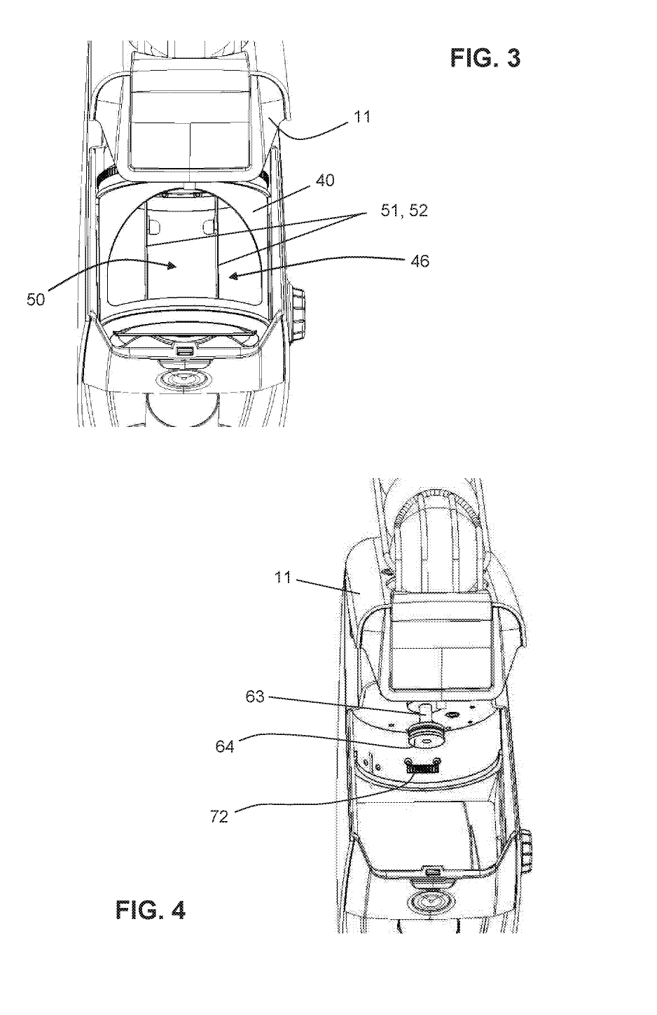

FIGS. 1 and 2 show a pressing device 1 according to an exemplary embodiment of the present invention, which is especially suitable for pressing oranges 2 in order to obtain juice from the oranges 2. The pressing device 1 comprises a housing 10 for accommodating components of the device 1 which are involved in performing a pressing action during operation of the device 1 as will be explained later on. A portion 11 of the housing 10 which is present at a side of the pressing device 1 which is a top side in a normal operational orientation of the device 1, which is the orientation of the device 1 as shown in the FIGS. 1-4, constitutes a lid 11 which is hingably arranged so as to assume one of a closed position as shown in FIG. 1 and an opened position as shown in FIG. 2. In the opened position of the lid 11, an interior of the pressing device 1 is exposed, as can be seen in FIGS. 3 and 4. For sake of completeness, it is noted that all references to orientations and/or locations of components of the pressing device 1 in this text with respect to FIGS. 1-9 should be understood in the context of the operational orientation of the pressing device 1.

The pressing device 1 comprises a holder 12 for holding a number of oranges 2, which is located on top of the lid 11. Due to the presence of the holder 12, it is possible to press a number of oranges 2 one after another without a user of the pressing device 1 being compelled to supply the oranges 2 one by one. Preferably, the holder 12 has an inclined orientation with respect to the horizontal, so that a supply of oranges 2 can automatically take place under the influence of gravity. This is advantageous in view of the fact that the pressing device 1 is well suited for domestic use, wherein it is not only preferred to have small dimensions, but also to have a simple and reliable construction. A lowest end of the holder 12 is at a location above an opening 13 in the housing 10 for allowing an orange 2 to move to the interior of the pressing device 1.

In the shown example, the housing 10 is provided with a recessed portion 14 for partially accommodating a glass 20 or another receptacle for receiving orange juice from the pressing device 1. At a top side of the recessed portion 14, an outlet of the pressing device 1 is present for allowing juice to flow from the interior of the device 1 to outside the device 1.

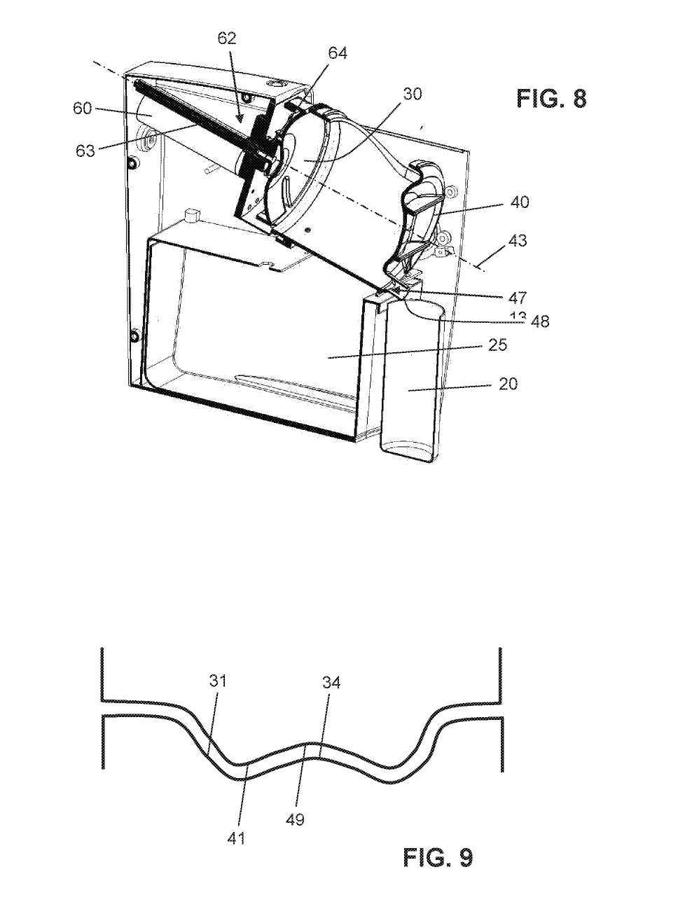

Furthermore, the pressing device 1 comprises means for allowing a user of the device 1 to control operation of the device 1, such as an on/off switch, a button for setting a quantity of juice to be produced by the device 1, buttons or options for indicating the pulp content of the juice, etc. Also, in the interior of the pressing device 1, a waste receptacle 25 as indicated in FIG. 8 is present for receiving and accommodating remainders of oranges 2 which have been subjected to a pressing action, which may be designed such as to be a kind of drawer which is movably arranged in the housing 10, for example.

Basically, the operation of the pressing device 1 has the following aspects. In the first place, a user of the pressing device 1 takes care that a suitable number of oranges 2 is present in the holder 12, and that a glass 20 or another suitable receptacle is put in place under the outlet of the device 1, wherein the shape of the recessed portion 14 of the housing 10 guides the user in finding a correct position of the glass 20. In the second place, the user activates the pressing device 1, as a result of which a first orange 2 is allowed to enter the interior of the device 1 where the orange 2 is subjected to a pressing action, as a whole, i.e. without being cut in separate pieces first. During the pressing action, juice flows from the outlet of the pressing device 1. At the end of the pressing action, the remainder of the orange 2 is allowed to fall into the waste receptacle 25. The process may be repeated with as many oranges 2 as desired in order to have a desired quantity of juice.

From time to time, the user should remove the waste receptacle 25 from the pressing device 1 and empty the waste receptacle 25, so that there is room for new remainders of oranges 2. Furthermore, the user can take out components as arranged in the interior of the pressing device 1 for cleaning purposes, by putting the lid 11 to the opened position.

In principle, the pressing device 1 is adapted to perform a pressing action on a whole orange 2 by positioning the orange 2 between two opposite surfaces and moving the surfaces towards each other. In order to have simplicity of design, it is preferred to only move one of the surfaces in the process, while another of the surfaces is kept at a fixed position. Furthermore, the pressing device 1 is adapted to make at least one cut in the orange 2 in order to have an outlet for the juice, through the peel of the orange 2, and in order to prevent ripping of the orange 2 during the pressing action, so that the sweet taste of the juice is not ruined by a substantial amount of bitter oil which would otherwise be released from the skin and mix with the juice.

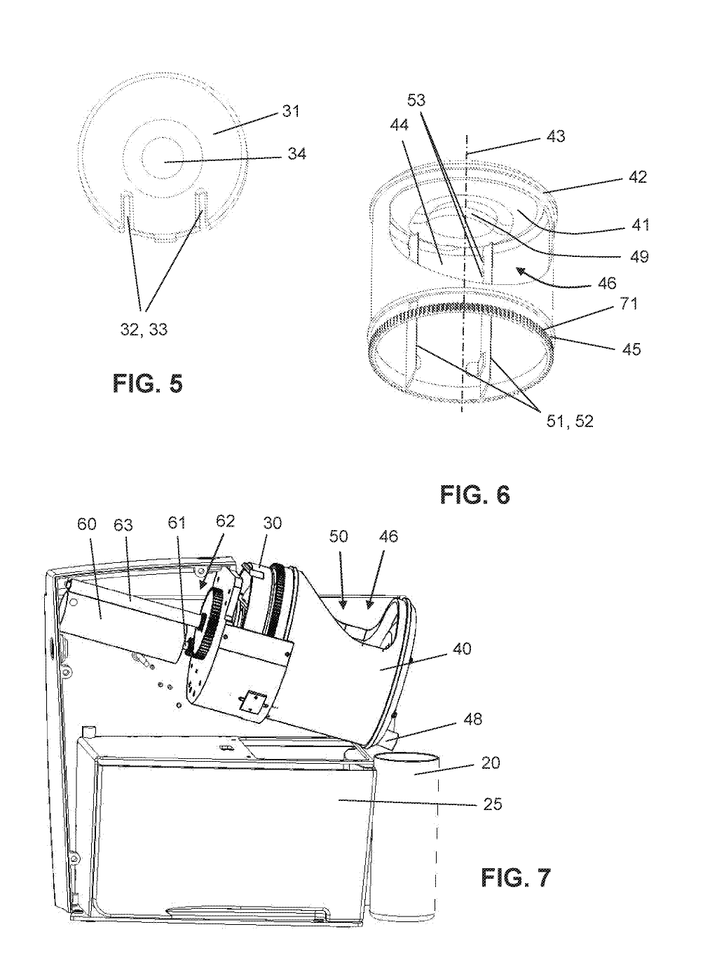

The pressing device 1 comprises two pressing elements 30, 40 as can be seen in FIG. 3, comprising pressing surfaces 31, 41 for contacting an orange 2 at opposite sides and pressing the orange 2. One of the pressing elements 30, 40 is generally shaped like a disc, and is shown separately in FIG. 5. For sake of clarity, this pressing element will hereinafter be referred to as pressing disc 30. Another of the pressing elements 30, 40 is generally shaped like a hollow cylinder, and is shown separately in FIG. 6. For sake of clarity, this pressing element will hereinafter be referred to as pressing cylinder 40. The pressing surface 41 of the pressing cylinder 40 is a major part of an inner surface of a closed end 42 of the cylinder 40. The dimensions of the pressing disc 30 are chosen such that the disc 30 snugly fits inside the pressing cylinder 40, wherein an outer periphery of the disc 30 is closely surrounded by a portion of an inner surface of the cylinder 40. The pressing disc 30 is movable in a direction towards and away from the pressing surface 41 of the pressing cylinder 40, in a direction in which a longitudinal axis 43 of the cylinder 40 extends, wherein a major part of a surface of the disc 30 facing the pressing surface 41 of the cylinder 40 constitutes the pressing surface 31 of the disc 30. During a pressing action, only the pressing disc 30 is moved, while the pressing cylinder 40 is kept in a fixed position.

In the shown example, the pressing cylinder 40 is a straight cylinder, wherein a side of the cylinder has curved inner and outer surfaces with a circular cross-section. Hence, the outer periphery of the pressing disc 30 has a circular shape as well. In fact, the pressing disc 30 functions as a movable end of the pressing cylinder 40, as it were. The assembly of the pressing disc 30 and the pressing cylinder 40 define a generally cylinder-shaped pressing chamber 50 having a variable size due to the movable arrangement of the disc 30. In particular, the pressing surface 31 of the pressing disc 30 serves as one end surface of the pressing chamber 50, the pressing surface 41 of the pressing cylinder 40 serves as an opposite end surface of the pressing chamber 50, a side surface 44 of the pressing cylinder 40 serves as a side surface of the pressing chamber 50, and the longitudinal axis 43 of the pressing cylinder 40 serves as a longitudinal axis of the pressing chamber 50.

As mentioned in the foregoing, the pressing cylinder 40 has a closed end 42. Furthermore, the pressing cylinder 40 has an open end 45, in order to allow the pressing disc 30 to enter the cylinder 40 from outside the cylinder 40 and to allow driving means to engage with the disc 30 as will be explained later on. Also, an entrance opening 46 is present in the side of the pressing cylinder 40. The entrance opening 46 serves for allowing an orange 2 to move to inside the pressing cylinder 40 from the opening 13 in the housing 10 at the lowest end of the holder 12. Inside the pressing cylinder 40, at a position of the side of the cylinder 40 opposite to the entrance opening 46, two knives 51, 52 are arranged on the inner surface of the cylinder 40. It should be noted that the number of knives 51, 52 need not be two, but may alternatively be one, three, or more, for example. In the shown example, the knives 51, 52 comprise straight cutting blades, extending substantially in parallel in the direction in which the longitudinal axis 43 of the pressing cylinder 40 extends. The pressing disc 30 is provided with two recesses 32, 33 for allowing the pressing disc 30 to move over the knives 51, 52 during a pressing action or a retracting action.

For the purpose of driving the pressing disc 30 and exerting a pressing force which is needed during a pressing action, the pressing device 1 comprises suitable driving means. In the shown example, the driving means comprise an electromotor 60 having an outgoing shaft 61, as can be seen in FIGS. 7 and 8. Furthermore, the driving means comprise a spindle drive 62. When the outgoing shaft 61 of the motor 60 rotates, a spindle 63 of the spindle drive 62 is extended or retracted. The pressing disc 30 is removably coupled to an end of the spindle 63, so that the disc 30 is moved deeper in the pressing cylinder 40 or retracted from the cylinder 40 under the influence of the motor 60. It will be understood that other types of driving means can be employed, as long as the desired movements of the pressing disc 30 can be realized. FIG. 4 illustrates how a portion of the spindle 63 with a coupling arrangement 64 at an end thereof extends inside the interior of the pressing device 1 in one of the many possible positions of the spindle 63 in the device 1.

It is advantageous for the pressing cylinder 40 to be rotatable about its longitudinal axis 43, as in that way, it is possible to move the cylinder 40 between a position in which the entrance opening 46 in the side of the cylinder 40 is up, so that an orange 2 can be received inside the cylinder 40, and a position in which the entrance opening 46 is down, so that an orange 2 can be discharged to the waste receptacle 25, which is preferably arranged right underneath a space of the pressing device 1 for accommodating the pressing disc 30 and the pressing cylinder 40. Also, it is possible to move the pressing cylinder 40 to a position in which the entrance opening 46 is displaced somewhat with respect to the position in which the opening entrance 46 is up, so that a subsequent orange 2 from the holder 12 is prevented from entering the inside of the cylinder 40 and hindering the pressing action of an orange 2 which has just been admitted to the cylinder 40. As an alternative, it is possible to have separate means at the opening 13 in the housing 10 for blocking and unblocking the opening 13.

Various ways of driving the pressing cylinder 40 such as to perform a rotating movement can be employed. In the shown example, the pressing cylinder 40 is provided with a gear ring 71 at its open end 45, wherein the pressing device 1 is equipped with a gear 72 for engaging with the gear ring 71 and an electromotor (not shown) for driving the gear 72, which is much smaller than the electromotor 60 for driving the pressing disc 30, as the pressing forces needed during a pressing action are much higher than the force which is needed for forcing the cylinder 40 to rotate.

During a pressing action of an orange 2, juice flows out of the orange 2 and flows over a portion of the side of the pressing cylinder 40, particularly a portion having a position at the bottom, which is a portion opposite to the entrance opening 46. Preferably, bases of the knives 51, 52 are provided with openings 53 in order to allow juice to pass to the lowest area of the pressing cylinder 40 as present between the knives 51, 52. FIGS. 7 and 8 clearly illustrate the fact that it is preferred to have an inclined position of the assembly of the pressing disc 30, the pressing cylinder 40 and the means for driving the disc 30 with respect to the horizontal, so that it is ensured that juice flows towards the closed end 42 of the cylinder 40. At the position where the closed end 42 is connected to the lowest area of the pressing cylinder 40, a discharge opening 47 and a discharge tube 48 connected to the cylinder 40 at the position of the discharge opening 47 are provided. For sake of completeness, it is noted that a default position of the pressing cylinder 40 for the purpose of a pressing action is assumed, i.e. a position as shown in the various figures, with the entrance opening 46 up, unless otherwise indicated. A coarse filter, a constriction or the like may be arranged in the discharge opening 47 for stopping possible pips from flowing along with the juice towards the glass 20. When the pressing cylinder 40 is rotated at the end of a pressing action for discharging the remainder of the orange 2 to the waste receptacle 25, it is achieved that the pips fall to the waste receptacle 25 as well.

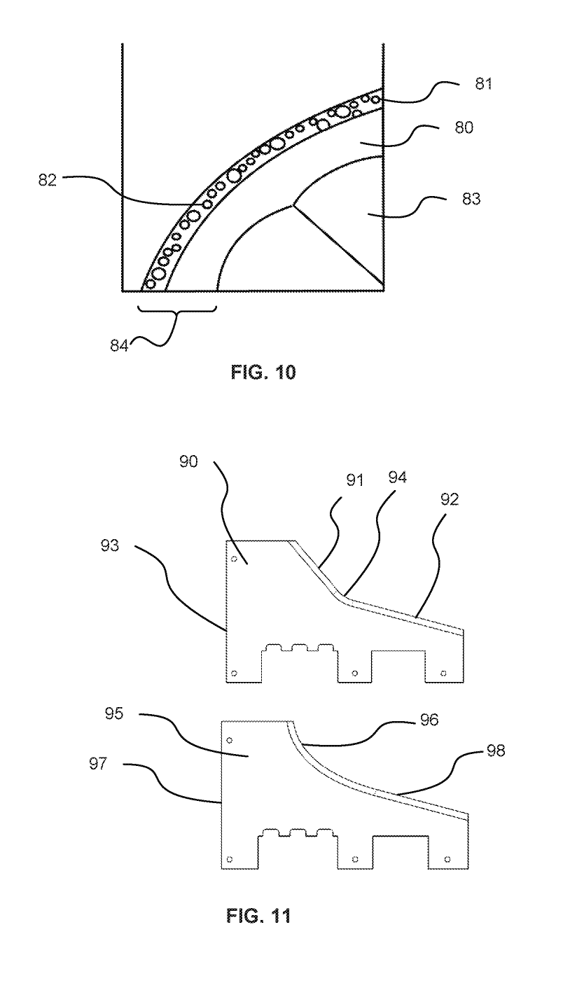

With reference to FIG. 9, it is noted that the pressing surfaces 31, 41 have special shapes which are aimed at preventing ripping of the peel of an orange 2 to be pressed. FIG. 9 shows a side view of central sections through the pressing surfaces 31, 41, in which it can be seen that the pressing surfaces 31, 41 have complementary curved shapes. In particular, the pressing surface 31 of the pressing disc 30 has a generally concave shape, with a convex central portion 34, whereas the pressing surface 41 of the pressing cylinder 40 has a generally convex shape, with a concave central portion 49. It will be understood that in principle, it is also possible for the pressing surface 31 of the pressing disc 30 to have a generally convex shape, with a concave central portion, and for the pressing surface 41 of the pressing cylinder 40 to have a generally concave shape, with a convex central portion. Furthermore, the pressing surfaces 31, 41 may simply have shapes which are overall concave and overall convex, respectively, but it is preferred to have the central portions 34, 49 with the inverse shapes, as it has been found that the presence of such portions 34, 49 help in preventing even thick peels from ripping, due to a reducing effect on a curve length difference between two opposite sides of an orange 2 to be pressed.

When the pressing device 1 is used for making juice, an orange 2 to be pressed in the process follows a path through the device 1 and is subjected to a pressing action in a way as will be explained in the following. In the first place, the orange 2 is allowed to fall to the inside of the pressing cylinder 40 through the opening 13 in the housing 10 at the lowest end of the holder 12 and the entrance opening 46 of the cylinder 40. This is done by having the pressing disc 30 in a retracted position and having the pressing cylinder 40 in a position with the entrance opening 46 up, so that there is a free passage for the orange 2. As soon as the orange 2 is in place in the pressing cylinder 40, the opening 13 in the housing 10 may be blocked, so that a subsequent orange 2 is prevented from directly following the orange 2.

When the orange 2 falls into the pressing cylinder 40, the orange 2 comes to rest on the knives 51, 52. Probably, the knives 51, 52 already cut through the peel of the orange 2 and some of the pulp of the orange 2 in the process. If not, the cutting action will take place during the pressing action, when the orange 2 is pressed between the pressing surfaces 31, 41 and is thereby made to expand in the direction of the knives 51, 52.

When the orange 2 is in place in the pressing cylinder 40, the electromotor 60 for driving the pressing disc 30 through the spindle drive 62 is activated, as a result of which the pressing disc 30 is moved in the direction of the closed end 42 of the cylinder 40. As soon as the pressing disc 30 contacts the orange 2, the actual pressing action starts, wherein the orange 2 is squeezed between the pressing surface 31 of the disc 30 on the one side and the pressing surface 41 of the pressing cylinder 40 on the other side as the movement of the disc 30 is continued. In the process, two cuts are made at a bottom side of the orange 2, if this has not already happened when the orange 2 entered the pressing cylinder 40, as explained in the foregoing. The fact is that the orange 2 is deformed as a result of the pressing action, wherein the orange 2 expands in the direction of the knives 51, 52, so that the orange 2 is pressed on the knives 51, 52, as it were, under the influence of the pressing forces prevailing during the pressing action.

The fact that the orange 2 is deformed is one effect of the pressing action. Another effect of the pressing action is the fact that juice is extracted from the orange 2, wherein the cuts in the orange 2 serve as outlets through the peel of the orange 2. As the knives 51, 52 are positioned at a bottom of the pressing cylinder 40, it is achieved that the juice can fall directly from the orange 2 to the inner surface of the pressing cylinder 40, so that the juice is prevented from flowing over the peel. Contact between the juice and the peel is minimized in order to improve the taste of the juice. The juice minimally contacts the peel at the position of the cuts, which should not expel a substantial amount of peel oil in the juice. During the pressing action, the juice which is released from the orange 2 through these cuts flows directly towards the glass 20 under the influence of gravity, along the inner surface of the pressing cylinder 40 and through the discharge opening 47 of the cylinder 40 and the discharge tube 48.

As explained in the foregoing, the shapes of the pressing surfaces 31, 41 play a role in reducing the incidence of ripping of the peel of the orange 2 during the pressing process. The peel has some elasticity, and by controlling the way in which the peel is cut and deformed, a situation is created in which the forces acting in the peel are not so high as to cause the peel to rip at one or more places. If, despite of all the measures taken, the peel rips anyway, this is likely to occur only near the end of a pressing action when deformation of the orange 2 and its peel is largest, when most of the juice has already been removed from the orange 2 and there is a lower risk that oil from the peel is flushed from the peel along with juice.

When the pressing disc 30 is at a close enough distance to the closed end 42 of the pressing cylinder 40, the operation of the electromotor 60 is reversed, as a result of which the pressing disc 30 is retracted. When the pressing disc 30 has been moved out of the pressing cylinder 40, the cylinder 40 is made to rotate about its longitudinal axis 43, in order to put the cylinder 40 to a position in which the entrance opening 46 is at a bottom side, so that the deformed remainder of the orange 2 is allowed to slide off the knives 51, 52 and fall to the waste receptacle 25, through the entrance opening 46. Optionally, the pressing device 1 may comprise means for pushing the orange 2 in a downward direction such as to guarantee that the orange 2 is released from the knives 51, 52.

Advantageously, the pressing disc 30 can easily be detached from the spindle 63, so that the pressing disc 30 can easily be removed from the pressing device 1. For example, a coupling between the pressing disc 30 and the spindle 63 may simply be a coupling in which the pressing disc 30 is suspended from the spindle 63 on the basis of gravity. Hence, it is only necessary to lift the pressing disc 30 from its position when it is desired to remove the disc 30. Furthermore, the pressing cylinder 40 may be supported by a surface of the interior of the pressing device 1 without any attachment to the surface, so that the cylinder 40 can easily be taken out of the device 1 when desired. Easy removal of the pressing disc 30 and the pressing cylinder 40 is advantageous in view of cleaning purposes. The pressing disc 30 and the pressing cylinder 40 only need to be rinsed. The pressing action as performed with the pressing device 1 is a relatively clean action in view of the fact that the pulp stays inside the oranges 2. A factor which contributes to simplicity of design of the pressing device 1 is constituted by the fact that oranges 2 are pressed as a whole, so that there is no need for having means for cutting the oranges 2 into segments, transporting the segments, etc. Also, the pulp of the orange 2 stays inside the orange 2, so that filtration of the juice by a sieve or the like is not required. During a pressing action, at least one cut is made in the orange 2 in an automated fashion by means of at least one fixedly arranged knife 51, 52, so that complex cutting movements can be avoided. Furthermore, oranges 2 to be pressed automatically follow a path through the pressing device 1 under the influence of gravity, from the holder 12 which is present on top of the pressing device 1 to the waste receptacle 25 after having been subjected to a pressing action. Juice also flows automatically from the oranges 2 to a receptacle such as a glass 20 under the influence of gravity.

The pressing disc 30 and the pressing cylinder 40 as shown are to be understood as just being examples of mutually movable pressing elements of the citrus fruit pressing device 1. Aspects like the holder 12 and the recessed portion 14 of the housing 10 may be omitted or replaced by alternatives. The cylinder shape of the pressing chamber 50 does not necessarily need to have a circular circumference; other shapes of the circumference can be employed.

The exemplary embodiments described herein are very well suited to be applied in a domestic environment, as explained in the foregoing. The pressing device 1 may be equipped with means for driving the pressing disc 30 as explained in the foregoing, but it is also possible for the device 1 to be hand-driven. In such as case, a lever construction or the like can be used for allowing a user to manipulate the pressing disc 30 and to provide the necessary forces at the location where the pressing action takes place. Another possible application is an application in an industrial environment, wherein the pressing device 1 may be adapted to different sizes of pieces of citrus fruit. In this respect, it is noted that embodiments do not only relate to a citrus fruit pressing device 1, but also relate to a method for pressing juice from a piece of citrus fruit 2.

In particular, a method for pressing juice from a piece of citrus fruit 2 comprises the steps of providing two opposite pressing surfaces 31, 41 which are movable towards each other and away from each other, arranging the piece 2 between the pressing surfaces 31, 41, making at least one cut in the piece 2, through the peel of the piece 2, in an area of the piece 2 which is free from contact to the pressing surfaces 31, 41, and pressing the piece 2 as a whole by moving the pressing surfaces 31, 41 towards each other. As explained in the foregoing, at least one cut is made in the piece of citrus fruit 2 in order to allow the juice to come out of the piece and reduce tensions in the peel of the piece 2 during deformation, wherein the cut is made in an area other than the areas contacting the pressing surfaces 31, 41, as a result of which the incidence of ripping of the peel is reduced because tensions prevailing in the peel during a pressing action are reduced.

Preferably, a cut is made in the piece 2 at a side of the piece 2 which is a bottom side in the arrangement of the piece 2 between the pressing surfaces 31, 41. In this way, besides reducing the incidence of ripping of the peel, which can cause bitter oil to be released and mixed with the juice, contact between the juice and the peel can be minimized, as explained above.

Advantageously, at least one knife 51, 52 is applied for making the at least one cut in the piece of citrus fruit 2, wherein contact between the knife 51, 52 and the piece 2 is maintained as the piece 2 is pressed, and wherein the knife 51, 52 is kept at a location to which the piece 2 expands as a result of its deformation. Furthermore, it is practical to provide a pressing element 40 which comprises one of the pressing surfaces 31, 41 and an opening 46 for allowing the piece of citrus fruit 2 to pass from outside the pressing element 40 to inside the pressing element 40. In that case, the piece 2 is supplied to the pressing element 40, wherein the piece 2 is held in the pressing element 40 as the piece 2 is pressed, and wherein the pressing element 40 is rotated after pressing has taken place in order to bring its opening 46 to a bottom position for allowing the piece 2 to fall out of the pressing element 40 under the influence of gravity. Hence, the piece 2 can simply be allowed to fall to a suitable waste receptacle 25 without a need of applying separate means for discharging the piece 2 from the pressing element 40.

As such, a citrus fruit pressing device 1 in accordance with one embodiment comprises two pressing elements 30, 40 for performing a pressing action on a piece of citrus fruit 2, which pressing elements 30, 40 have surfaces 31, 41 for contacting different sides of a piece of citrus fruit 2 to be pressed, and which pressing elements 30, 40 are movable with respect to each other in two opposite directions, i.e. towards each other and away from each other. Furthermore, the pressing device 1 comprises cutting means for performing a cutting action on a piece of citrus fruit 2, through the peel of the piece 2, which cutting means are arranged for penetrating into the piece 2 from a side which is free from contact to the surfaces 31, 41 of the pressing elements 30, 40.

In a practical embodiment, the citrus fruit pressing device 1 comprises a generally cylinder-shaped pressing chamber 50 having an interior space for receiving a piece of citrus fruit 2 to be pressed, which pressing chamber is partially delimited by the surfaces 31, 41 of the pressing elements 30, 40. In particular, the surface 31 of one pressing element 30 constitutes one end surface 31 of the pressing chamber 50, and the surface 41 of another pressing element 40 constitutes an opposite end surface 41 of the pressing chamber 50. The size of the pressing chamber 50 is changed by moving the pressing elements 30, 40 with respect to each other, wherein a piece of citrus fruit 2 is squeezed between the surfaces 31, 41 of the pressing elements 30, 40 as the surfaces 31, 41 are made to move towards each other. Furthermore, the cutting means are adapted to perform a cutting action on a piece of citrus fruit 2 inside the pressing chamber 50, and therefore comprise at least one knife 51, 52 which is arranged inside the pressing chamber 50 on a side surface 44 of the pressing chamber 50.

On the basis of the application of the pressing elements 30, 40 and the at least one knife 51, 52 in the citrus fruit pressing device 1, a compact and simple design of the pressing device 1 can be realized, so that the pressing device 1 can be operated in a reliable manner. Also, by having at least one knife 51, 52 arranged at a side position with respect to the surfaces 31, 41 which serve as pressing surfaces during a pressing action, at least one defined cut is made in a piece of citrus fruit 2 to be pressed, which does not only have a function in allowing juice to flow from the piece 2, but also in preventing the peel of the piece 2 from ripping at the cut, thereby helping to ensure that the sweet taste of the juice which is obtained from the piece 2 is preserved.

In accordance with alternative aspects, the taste of the juice can be further improved in a variety of ways. As illustrated in FIG. 10, an orange 83 includes an outer skin/peel 81 and an inner skin/peel 80 forming the peel 84. A bitter taste in orange juice can result from rupturing oil pockets/glands 82 in the outer skin 81 and mixing the oil with orange juice. The oil in the glands, d-limonene, can cause the bitter flavor. Thus, it is preferable have as little of this oil as possible in the juice, as more than 6.5 ug/mL (ppm) can give a detectable bitter taste.

The glands are substantially spherical pockets of oil. Thus, deformation of the skin can deform the glands and can increase the internal pressure in the glands. When the orange is cut, a row of glands will be sliced and opened. The amount of oil from a sharp cut is relatively low. As such, a certain length of cut in an orange can be formed without introducing a noticeable effect on taste. In contrast, when an uncut orange is partly squeezed, the skin and glands are placed under pressure. At a certain point, the skin will tear or rip. At this point, a wide section of glands, for example, on the order of 1 cm, is affected and a relatively large amount of oil can be released.

The peel of an orange has a small amount of elasticity. In accordance with one exemplary aspect, the knives in the system can be configured to enable a deformation of the orange skin from a ball or round shape to a flat shape without creating rips and tears. Flattening the shape of the orange in this way is preferable to prevent the tearing or rupturing of oil pockets in the orange skin when opposing sides of the orange are pressed together between the pressing elements. Here, a plurality of parallel knives can be employed. The separation space or distance between any two of the knives is preferably limited in that the stretch of peel in between the knives is flattened. For example, for a relatively small orange, if more than 40-50 mm of peel is flattened, then the elasticity of the orange can prevent the peel from changing from a curved (spherical) shape to a straight (flat) shape. A first tear can appear right in the middle of the knives as the limit is reached. The minimum distance of 40-50 mm is determined by the size of the oranges. For larger oranges, the knives may be placed further apart, but need not be. Thus, preferably, the minimum distance of 40-50 mm is employed between any two knives in the system so that the system can accommodate both small oranges and large oranges alike.

In accordance with one exemplary aspect, the knives 51, 52 can be replaced with knives 90 or knives 95, illustrated in FIG. 11. Both knives 90 and 95 include curved edges 94 and 96, respectively, and can be positioned such that ends 93 of knives 90 or ends 97 of knives 95 are disposed against the pressing surface 41 in FIG. 6. Thus, edge portions 92 and 98 can be disposed near an inner side surface 44 of the pressing housing 40, while edge portions 91, 96 can disposed nearer to the pressing element surface 41 than the pressing element surface 31. The knives can be parallel, as, for example, knives 51, 52 in FIG. 6, or affixed at an angle with respect to each other. As illustrated in FIG. 11, knives 95 include a straight edge 98 and a curved edge 96, which is essentially spherical. The edges 96 and 98 primarily compose the cutting edge of knife 95. In turn, the knives 90 include two edges 91 and 92, which primarily compose the edge 94, that are angled at an obtuse angle with respect to each other. In either case, the edges of the knives 90, 95 vary in angle from a relatively horizontal orientation (e.g., edges 92, 98) to a relatively vertical orientation (e.g., edges 91, 96). Preferably, the angle between the primary edges falls within the range 110° to 130°. Each of the knives include a first edge portion 92, 98 that is substantially parallel to the axis along which the pressing elements 30 and 40 exhibit relative motion and a second edge portion 91, 96 that is substantially perpendicular to the axis. “Substantially perpendicular” to the axis should be understood herein to mean within 45 degrees with respect to a line that is normal to the axis, while “substantially parallel” to the axis should be understood herein to mean within 45 degrees with respect to the axis. Further, the edge portions 92 and 98 can be disposed along an inner side surface 44 illustrated in FIG. 6, while the edge portions 91 and 96 can be disposed near the pressing surface 41 illustrated in FIG. 6, where the ends 93 and 97 can abut the pressing surface 41.

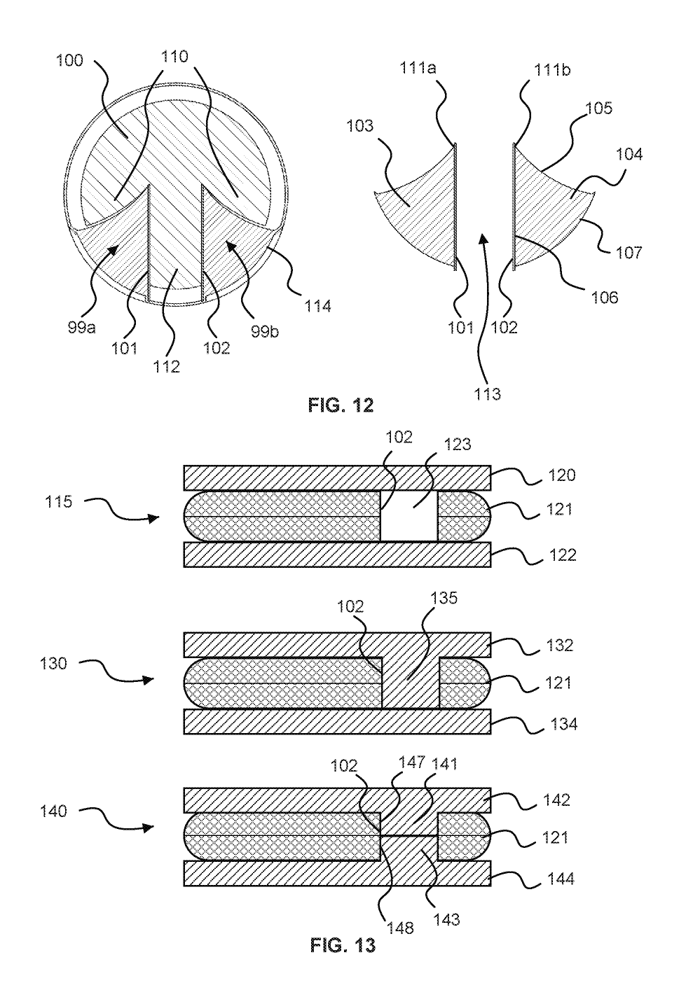

Due to their curved shape, each of the knives 90, 95 can provide a deeper cut while at the same time better prevent tearing of the orange as compared to the knives 51, 52. For example, FIG. 12 illustrates a diagram of an orange peel 100 that was cut by the knives 90. The final cuts can extend into the orange by about ⅔ of its diameter so that the sides can expand out during the pressing without any tears. When an orange lands on the knives, it stays in its position until it is pressed. When the orange is pressed as described above, the orange perimeter expands and the knives cut into the orange. Further, while pressing, the upward parts (e.g., edges 91 or 96) of the knives are engaged. The shape of these edges can enable the cuts to be made much deeper, preferably ˜⅔th the diameter of the orange, while at the same time permitting the sides of the peel to expand out without tearing. In this way, the sides 110 of the orange can move freely from the center and rips and tears in the side portions 110 of the peel can be avoided.

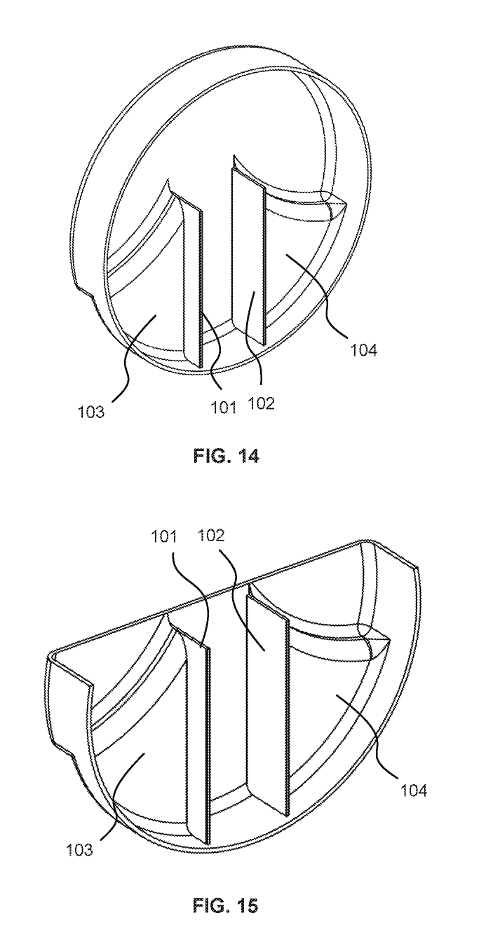

As illustrated in FIG. 12, spaces 99a and 99b in which no peel is present are formed in the orange peel 100 between the side portions 110 and the central portion 112, which occupies the space 113 and borders knives 101 and 102, which can be, for example, knives 90 or 95, when the orange is nearly completely pressed. Thus, as illustrated in FIG. 13, at the final pressing stage, the orange 121 is flat in between the two pressing surfaces 120, 122. The sides of the orange have moved away from the longitudinal cutting planes. From the top (sharp edge) of the knives, there is a roughly triangular area where the orange skin is not present.

In the example depicted in the top portion 115 of FIG. 13, the pressing elements 120, 122 have a somewhat flat shape. When pressing an orange, the press heads approach each other until all juice is pressed from the orange. This is when the distance between the heads is approximately two skin (peel) thicknesses. However, in the area 123 next to the knives 101 or 102 there is no peel, corresponding to the triangular area 99a or 99b discussed above. Thus, any pulp expelled from the orange into this area will not be pressed completely.

To ensure all or most of the pulp of the orange is pressed, protrusions 103 and 104, the cross sections of which are illustrated in FIG. 13, are formed in one or both of the pressing surfaces 31, 41 next to the knives 101, 102 respectively. In particular, the protrusions 103 and 104 can be configured to protrude toward the interior space of the pressing chamber and occupy essentially the entirety of spaces 99a and 99b, respectively. Each of the protrusions 103 and 104 should cover at least 75% of the areas of spaces 99a and 99b, respectively, which are defined by the space between edges of peel portion 112 and edges of peel portions 110. Other views of the protrusions 103 and 104 are provided in FIGS. 14-15. As illustrated in portion 130 of FIG. 13, a cross-section of one of the protrusions 103 or 104 is illustrated as element 135 disposed on one of the pressing elements 30 or 40, denoted as pressing element 132. In addition, the other opposing pressing element 30 or 40, denoted by element 134, can remain relatively flat. Therefore, in this specific location, at protrusion 135, the final distance in between the pressing heads 132 and 134 is not twice the peel thickness, but is close to zero. This ensures that the pulp residing in between the knife and the side part of the orange is pressed. Alternatively, each pressing element 30, 40 can include protrusions 103 and 104, where the thickness of the protrusions are approximately one peel thickness, as illustrated in portion 140 of FIG. 13. Here, pressing element 142, which can be implemented as pressing element 40, has a protrusion 141 on its inner surface with the approximate thickness of an orange peel, while pressing element 144, which can be implemented as pressing element 30, has a protrusion 143 on its inner surface also with the approximate thickness of an orange peel. Other thicknesses for the protrusions can be employed. Portions 130 and 140 illustrate only one of the protrusions 103 or 104. One or both of the surfaces 31 and 41 can include protrusions 103 and 104 defined, as discussed above, by the outside surface of the knives 101, 102, with various thicknesses, as illustrated in portions 130 and 140 of FIG. 13. Here, similar to the protrusion 104, the outside surface of blade 102 defines and delineates the surfaces 147 and 148 of the protrusions 141 and 143. It should be noted that the protrusions 103, 104 can be included in any of the pressing surfaces of pressing elements described herein and can be formed as mirror images of each other.

Preferably, the inside the protrusions are defined by the location of the knife blades. For example, surface 106 of the protrusion 104 is delineated by the outside of the blade 102 illustrated in FIG. 12. Protrusion 103 is defined similarly with respect to the outside of the blade 101, as illustrated in FIG. 12. Here, the outside surfaces of the blades 101 and 102 that are disposed against the protrusions 103 and 104 oppose the sides of the blades 101 and 102 that border the space 113, which, as noted above, is preferably at or between 40-50 mm wide along the horizontal axis of the view depicted in FIG. 12. Towards the outside, the protrusions are preferably configured to closely match the final shape of the orange peel. The top corners 111a and 111b of the protrusions are disposed close to the top edges of the knives 101 and 102, respectively. The protrusions expand to the side at an angle or curve, as illustrated for example by edge 105 of the protrusion 104, in principle following the shape of the pressed orange sides 110. The general direction of the edge 105 is 45 degrees from the knife blade direction. The protrusion can expand all the way to the inner surface 114 of the pressing chamber, as illustrated by edge 107 of protrusion 104, which is defined by the inner surface of the pressing housing 40. Thus, the side 106 of the protrusion 104 matches a shape of the knife 102, the side 107 of the protrusion 104 matches a shape of the edge 114 of the pressing housing and side 105 protrusion 104 is curved and matches a shape of the peel 110 disposed outside of the separation space 113 after the peel is cut. The edge 106 is preferably, in general, as long as the radius of the pressed orange 100. The offset thickness of the protrusions 103 and 104 is preferably equal to twice the general peel thickness, which is approximately 3 to 10 mm, preferably 4-6 mm. Thus, in the embodiment illustrated in portion 130 of FIG. 13, the thickness of protrusion 135, along the vertical direction in the view illustrated in FIG. 13, is preferably between 3 to 10 mm, more preferably 4-6 mm. Similarly, the combined thickness of the protrusions 141 and 143 in portion 140 is preferably between 3 to 10 mm, more preferably 4-6 mm.

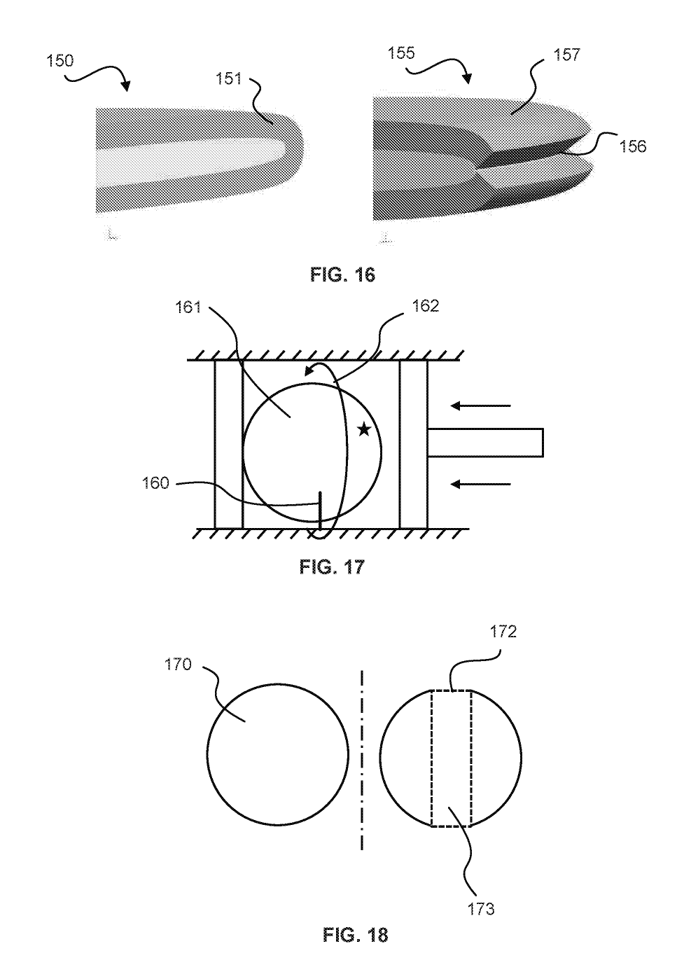

As noted above, rupture of the oil pockets within the peel of a citrus fruit, especially an orange, degrades the taste of the juice extracted from the fruit. When an orange is partly squeezed, the skin and glands are placed under pressure. At a certain point, the peel will tear and rip, causing a release of the oil in glands of the peel. Here, a wide section of glands, on the order of 1 cm, can be affected and can cause the release of a relatively large amount of oil. In particular, when the fruit is flattened, as illustrated in the flattened orange 150 in FIG. 16, the skin or peel 151 is folded over, causing a relatively large deformation and the release of a substantial spray of oil locally from the glands in the bend radius. As discussed above, the glands in the peel are round pockets of oil and when the skin or peel is deformed in this way, the pressure inside the glands increases due to the deformation. Within a certain radius, the pressure in the glands is released by bursting and a spray of bitter oil is formed. This spray can contaminate the juice and compromise the taste. The folding over a small radius can typically occur near the end of the pressing stroke in the systems described above, when the fruit is essentially flattened.

To address this problem, a variety of features can be employed. For example, the fruit can be cut at least partly along a circumference of the fruit prior to implementing the primary cuts with knives 51, 52, 90 and/or 95. Preferably, the fruit is cut along the equator of the fruit. Here, next to two longitudinal parallel cuts, as illustrated in FIG. 17, an extra cut 160 can be made around the perimeter 162 of the orange 161. The cut can be a very shallow cut and is preferably deeper than the outer orange skin 81 containing the glands 82 of oil, illustrated in FIG. 10. Preferably, the cut depth is 1 to 5 mm; however deeper cuts can also be employed. As illustrated in orange 155 in FIG. 16, the cut is preferably a hinged cut 156 that creates a hinge motion in the skin 157 and can avoid deformation of and/or pressure build in the oil glands.

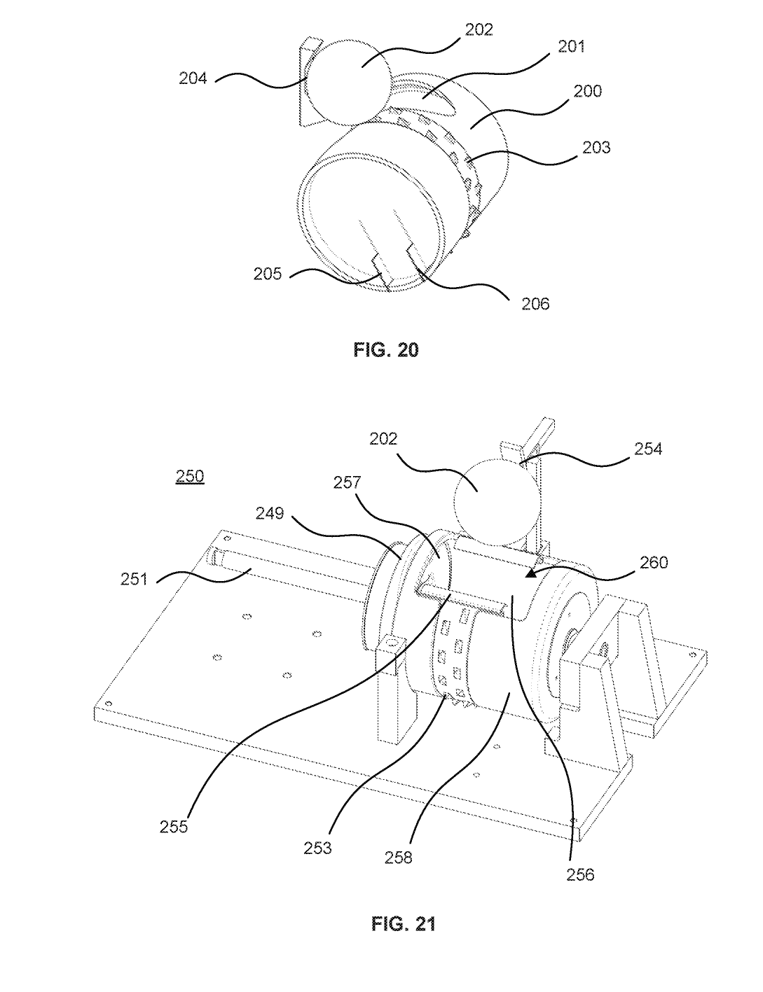

According to one exemplary embodiment, the system 1 can be modified by employing a pressing housing 200 in place of the cylinder/pressing housing 40. Here, as illustrated in FIG. 20, instead of dropping the orange directly into the housing, the opening 201 into the pressing chamber is moved and disposed so that the orange 202 lands on top of the pressing housing 200 after the orange 202 is dropped from holder 12 in FIG. 1. The housing 200 is rotated and gripping extensions 203 on the outside surface of the housing 200 drive the orange 202 counter-rotationally. The orange 202 thereby rotates over a small knife 204 in the side wall of the appliance as indicated in FIG. 20. While rotating, the orange 202 is cut at least partly over a circumference of the orange. Preferably, the orange 202 is cut completely over the circumference at the equator of the orange. With a full rotation of the housing 200, the orange 202 can drop through the opening 201 onto the knives 205, 206, which can be implemented as, for example, knives 51, 52, 90 and/or 95 and which can cut the orange to form cuts that are a primary means of expelling juice from the orange, as discussed above.

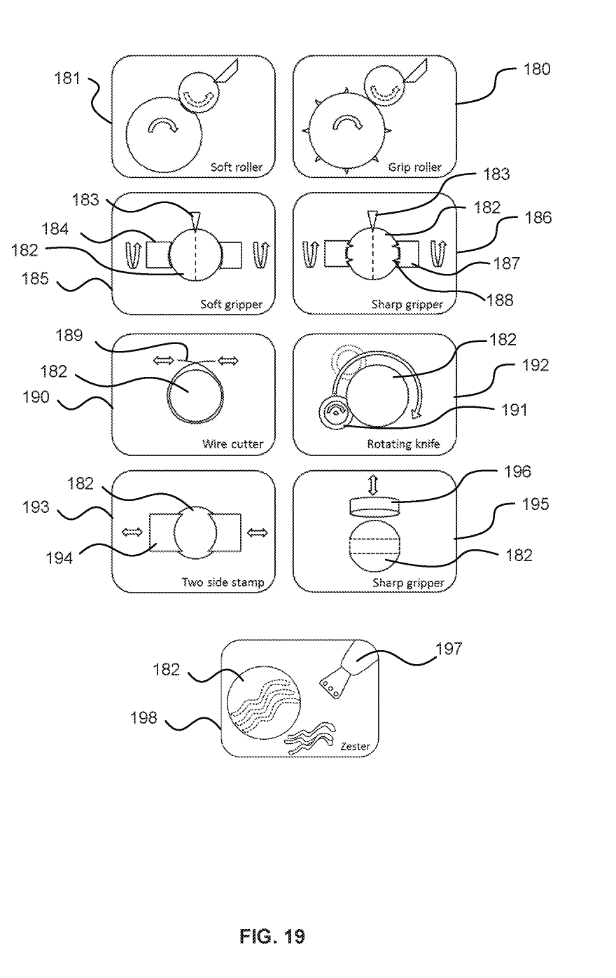

In accordance with an alternative embodiment of the present invention, as illustrated in FIG. 18, the skin of a citrus fruit 170 can be locally removed by employing a cookie cutter-type knife to obtain a wide cut 172. By removing the skin 84, or at least the outer peel 81, locally around the perimeter, the folding of the peel/outer peel is prevented entirely. Here, the surface 173 along the cut is still folded over when the orange is flattened by the pressing elements. Removing the skin can be implemented by pressing the orange through a tubular knife or by peeling around the orange using one of a variety of tools. FIG. 19 illustrates several embodiments for implementing a circumferential cut in a citrus fruit. Diagram 180 illustrates the embodiment discussed above with respect to FIG. 20, in which a grip roller is employed. Alternatively, the cut can be implemented on the outside of a pressing housing without gripping extensions, as illustrated in diagram 181. Alternatively, as illustrated in diagram 185, rotatable soft grippers 184 can be used within the pressing chamber of a pressing housing, such as housing 40 or 200 discussed above, where the cut is implemented using a knife 183 by rotating the grippers 184. Similarly, as illustrated in diagram 186, sharp grippers 187, including gripping extensions 188 to grip the orange 182, can be rotated to cut the orange 182 circumferentially with the knife 183. Alternatively, a wire cutter 189 can be utilized to perform the circumferential cut into the fruit 182, as illustrated in diagram 190. In addition, a rotating knife 191 can be used to form the circumferential cut in the fruit 182, as illustrated in diagram 192. Further, as shown in diagram 193, a two-side stamp 194 can be employed to press the circumferential cut into the orange 182. Additionally, diagram 195 illustrates the use of a tubular knife 196 to perform the circumferential cut into the orange 182, as discussed above with respect to FIG. 18.

In one exemplary embodiment, a zester 197 can be used to remove the peel 84 or the outer skin 81 of the peel, as illustrated in diagram 198 of FIG. 19. The peel/outer skin can be removed locally; however, use of the zester leaves strips of peel on the fruit. Because of their small width, the remaining strips should not undergo a high stress with a deformation of the skin in the normal direction. Because the zester works on a wider area, there is greater tolerance with respect to the location in which the circumferential cuts are applied.

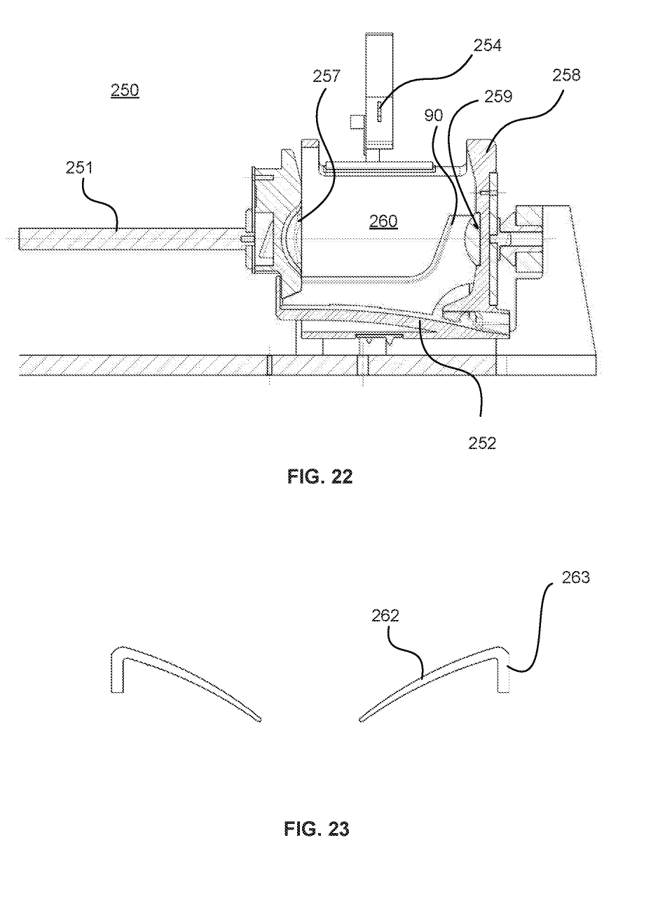

As discussed above, although the at least partly circumferential cut can be effective in reducing rupturing of oil pockets in the peel, when the fruit is dropped into a pressing chamber, it can be difficult to maintain the orientation of the fruit so that the surface of the fruit is folded at the cut when the fruit is pressed. FIGS. 21-22 illustrate one exemplary pressing apparatus/device 250 that can employed to maintain the proper orientation of the fruit 202. Here, the apparatus 250 can include a shaft 251 for turning a pressing surface 257 of a rotatable pressing element 249 to press and cut the fruit, as discussed above with respect to pressing device 1. In addition, gripping elements 253 can be applied on the outer surface of the pressing housing 258 to grip and rotate the fruit 202 and thereby implement an at least partly circumferential cut in the fruit 202 with the knife 254. The device can further include flaps 255 at an opening 256 to the pressing chamber 260, the ends of which are defined by pressing surface 257 of the pressing element 249 and the inner surface 259 of the housing 258, which acts as a second pressing element, opposing the surface 257. Knives 90 can be disposed within the pressing chamber 260. However, it should be understood that any of the knives 51, 52, 90, 95, and/or variations thereof can be employed. The apparatus 250 can further include a ramp 252 along which pressed juice can be expelled outside of the device.

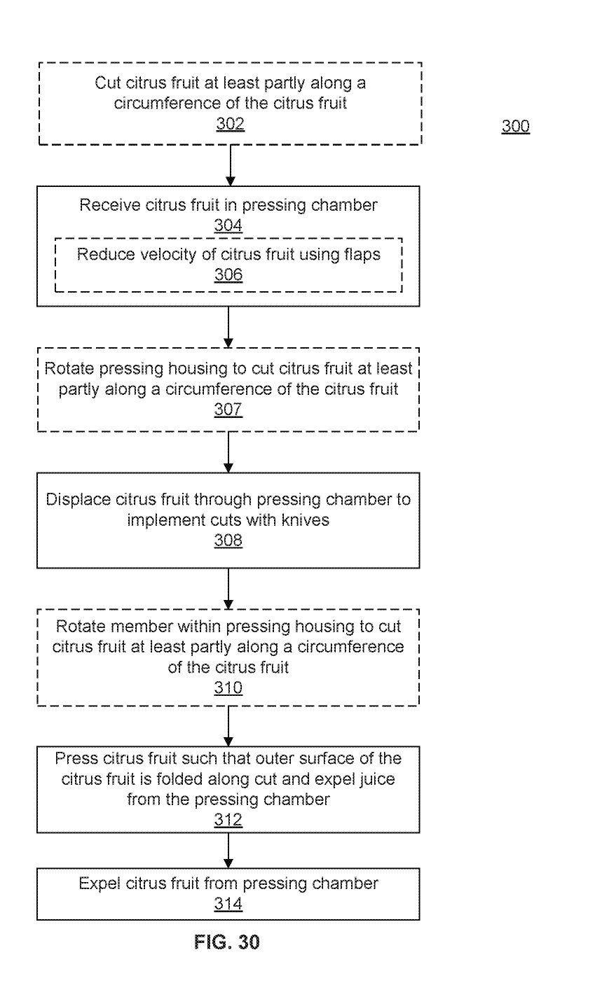

To better illustrate the operation of the apparatus 250, reference is made to FIG. 30, in which a method 300 for pressing juice from a citrus fruit in accordance with an exemplary embodiment of the present invention is illustratively depicted. It should be noted that the steps of the method 300, and the method 400 discussed herein below, need not be performed in the order illustrated in the figures. Optionally, the method 300 can begin at step 302, at which the citrus fruit can be cut at least partly along a circumference of the citrus fruit. For example, the housing 258 can be rotated and the gripping extensions 253 can be employed to grip and rotate the fruit 202 as the cutting element 254 cuts the fruit 202 outside of the pressing housing 258, as discussed above. One benefit of implementing the circumferential cut outside of the chamber is that a precise and accurate cut can be performed.

It should be further noted that, in each of the implementations of the method 300 described herein, the device/apparatus can be configured to press the citrus fruit such that an outer surface of the citrus fruit is folded along the cut. Preferably, the cut is a hinged cut in that the depth of the cut penetrates less than a thickness of the peel. For example, as discussed above, the depth of the cut can extend passed the outer skin 81 of the fruit, but not completely through the peel 84. Here, for example, the peel can be folded at the cut. In addition, it should be noted that any of the alternative implementations of the circumferential cut described above can be employed. For example, the device 250, and any of the devices described herein, can employ a tubular knife to perform the at least partial circumferential cut and remove at least part of the peel. Further, although a partial cut may be implemented in certain embodiments, preferred embodiments implement the cut completely around the circumference of the fruit at the equator.

At step 304, the citrus fruit 202 can be received in a pressing chamber 260. For example, as noted above, the gripping extensions 253 can roll the fruit 202 into the opening 256. Optionally, at step 306, the velocity of the fruit 202 can be reduced by employing flaps 255 such that an orientation of the citrus fruit is essentially maintained when the citrus fruit is passed into the pressing chamber and moved by the pressing element 249. To further aid in maintaining the orientation of the citrus fruit, the housing 258 can be disposed horizontally. Here, the axis along which the relative motion of the pressing elements 249 and 258 is implemented is essentially parallel to the surface on which the device/apparatus 250 rests. FIG. 23 illustrates an example of flaps 262 that can be employed in the device. The flexible flaps 262 preferably have a width in the order of 20 mm and are made from a durable and food-safe material composed of, for example, silicon rubber. The flaps 262 become thinner in cross section towards the center of the gap and to center the orange, as illustrated in FIG. 23, where ends 263 can be affixed to the housing 258.

At step 308, the fruit can be displaced through the pressing chamber to implement cuts with primary knives. For example, the pressing element 249 can be rotated as discussed above with respect to device 1 to displace the fruit through the pressing chamber 260 and perform primary cuts with knives 90. Here, the cuts are primary in that they are a primary means by which juice is pressed out of the citrus fruit, as the circumferential cuts in this embodiment are implemented principally to prevent tearing and ripping in the folds of the peel.

At step 312, the citrus fruit can be pressed by surfaces 257 and 259 such that the outer surface of the citrus fruit is folded along the cut and juice is expelled from the pressing chamber. For example, due to the horizontal disposition of the pressing chamber 258, the ramp 251 can be used to expel the juice out of the chamber and into, for example, a user's container.

At step 314, the citrus fruit, including its pulp and peel, can be expelled from the pressing chamber 258. For example, the fruit can be expelled in the same manner discussed above with respect to device 1. Here, the pressing housing 258 can be rotated and the fruit can be expelled through the opening 256 due to gravity.

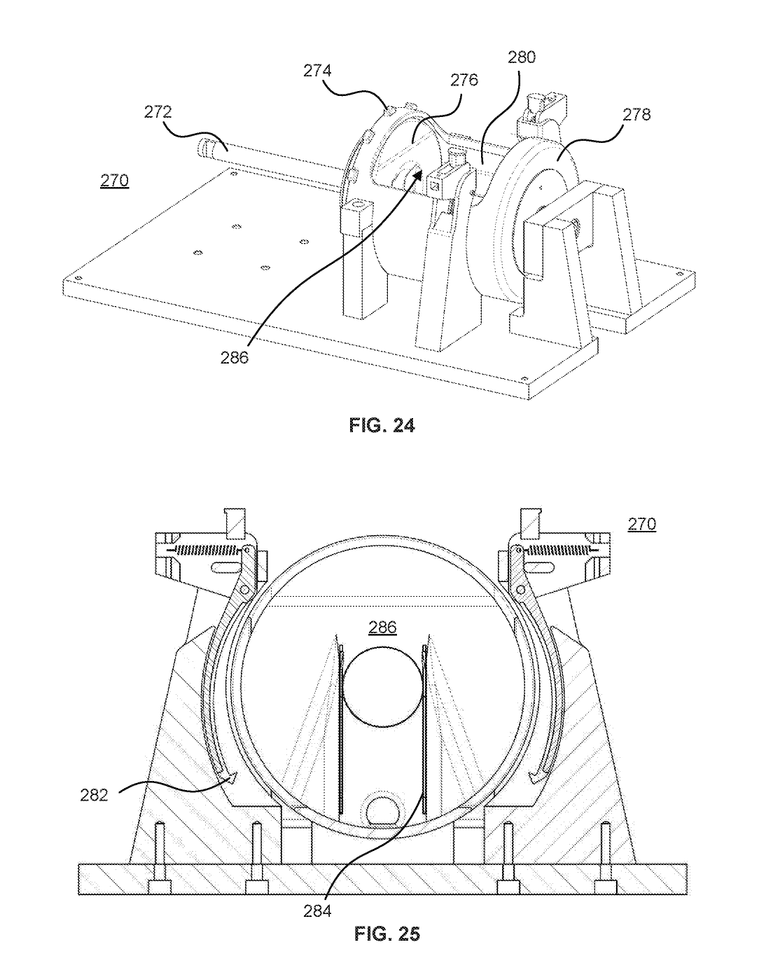

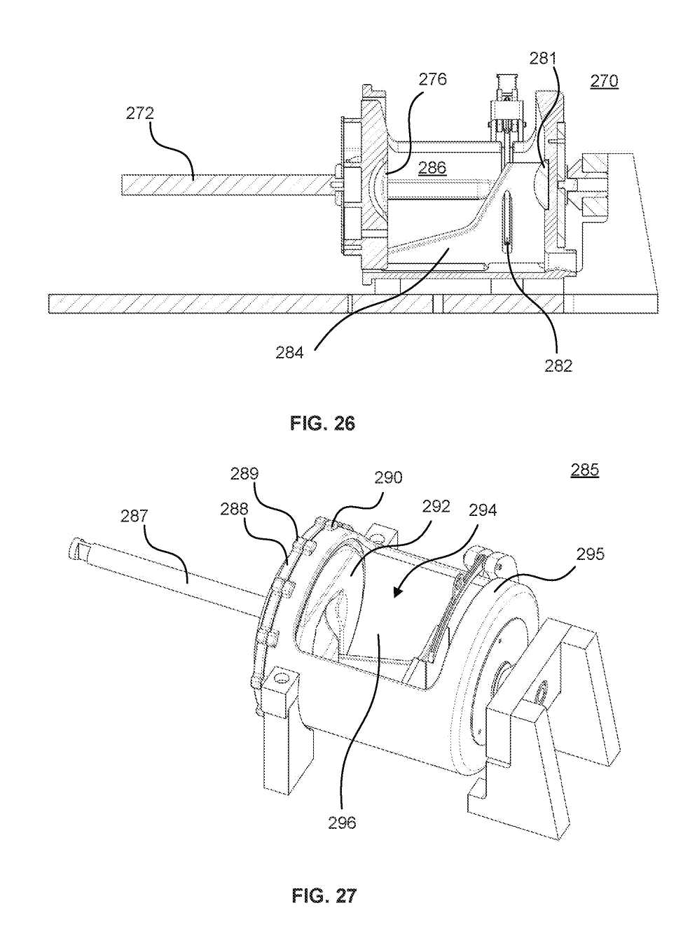

Turning now to FIGS. 24-26, an alternative citrus fruit pressing device/apparatus 270 is illustratively depicted. The apparatus 270 can maintain a proper orientation of the orange 202 by performing the at least partly circumferential cut within the pressing chamber 286. One advantage of performing the cut within the chamber is that the orientation of the fruit is much easier to control. Furthermore, it is also easer to accommodate different sizes of fruits when implementing the circumferential cut. To illustrate the operation of the apparatus 270, reference is made to FIG. 30. The method 300 can begin at step 304, at which the citrus fruit 202 can be received in the pressing chamber 286 through the opening 280, for example, as discussed above with respect to device 1, so that the fruit rests on the knives 284. The knives 284 can be implemented with any of the knives 51, 52, 90, 95, and/or variations thereof. As illustrated in FIGS. 24-26, two ends of the pressing chamber 286 are delimited by the pressing surface 276 and the inner surface 281 of the pressing housing 278.

Optionally, at step 307, spring-loaded, retractable knives 282 can be activated and disposed in the pressing chamber 286 and the pressing housing 278 can be rotated through gears 274 in an oscillating manner to implement cuts along a circumference of the fruit with the knives 282.

At step 308, the fruit can be displaced through the pressing chamber to implement primary cuts with primary knives 284 by driving the pressing surface 276 with the drive shaft 272, as discussed above with respect to the device 250.

At step 312, the citrus fruit can be pressed such that the outer surface of the citrus fruit is folded along the cut and juice is expelled from the pressing chamber. Here, the pressing housing 278 can be inclined to expel the juice, as discussed above with respect to the pressing device 1.

At step 314, the citrus fruit, including its pulp and peel, can be expelled from the pressing chamber 258. For example, the fruit can be expelled in the same manner discussed above with respect to device 1. The pressing housing 278 can be rotated and the fruit can be expelled through the opening 280 due to gravity.

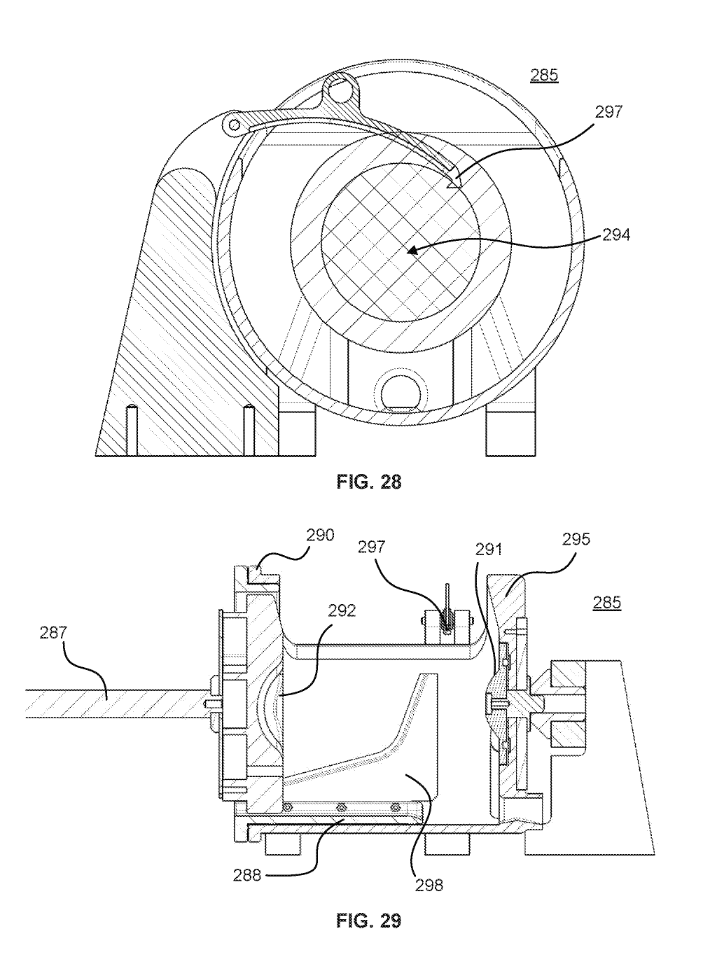

Referring now to FIGS. 27-29, another exemplary embodiment 285 of a citrus fruit pressing device apparatus is illustratively depicted. Similar to the device apparatus 270, the at least partly circumferential cut is also implemented inside the pressing chamber 294 to maintain a proper orientation of the fruit. However, here the apparatus includes an additional rotatable member 288 that can be rotated through gears 289. Furthermore, the knife 297 that implements the circumferential cut is disposed between the primary knives 298, which can be implemented with any of the knives 51, 52, 90, 95, and/or variations thereof, and the pressing surface 291 of the pressing housing 295. As discussed in more detail herein below, the configuration of the knives facilitates expulsion of the fruit after it is pressed.

To better illustrate the operation of the device 285, reference is again made to the method 300. The method can begin at step 304, at which the citrus fruit 202 can be received in the pressing chamber 294 through the opening 296, for example, as discussed above with respect to device 1, so that the fruit rests on the knives 298. As illustrated in FIGS. 27-29, two ends of the pressing chamber 294 are delimited by the pressing surface 292 and the inner surface 291 of the pressing housing 295.

At step 308, the fruit can be displaced through the pressing chamber to implement primary cuts with primary knives 298 by driving the pressing surface 292 with the drive shaft 287, as discussed above with respect to the device 250.

Optionally, at step 310, the rotatable member 288 within the housing 295 is configured to rotate the citrus fruit to implement the at least partly circumferential cut with the knife or cutting element 297. Here, the member 288 can be rotated 360 degrees, permitting the fruit to be cut entirely along a circumference of the fruit. As indicated above, the cutting element 297 is disposed between the cutting elements 298 and surface 291 of the pressing element 295. The circumferential cut is implemented after the primary cut when the fruit is moved between the pressing elements 288 and 295. As noted above, the positioning of the cutting elements 298 and 297 facilitates dropping the pulp and peel out of the pressing chamber, as the fruit can pass the primary knives completely and is less likely to be caught on the primary knives 298.

At step 312, the citrus fruit can be pressed by surfaces 292 and 291 such that the outer surface of the citrus fruit is folded along the cut and juice is expelled from the pressing chamber. Here, the pressing housing 295 can be inclined to expel the juice, as discussed above with respect to the pressing device 1.

At step 314, the citrus fruit, including its pulp and peel, can be expelled from the pressing chamber 294. For example, the fruit can be expelled in the same manner discussed above with respect to device 81. The pressing housing 295 can be rotated using gears 290 and the fruit can be expelled through the opening 296 due to gravity.

In accordance with another exemplary aspect, the pulp content of the juice can be controlled using the pressing speed of the relative motion between two pressing elements. In particular, by adjusting the speed of the pressing action, the amount of pulp expelled from the fruit with the juice can be controlled. It can be shown that faster pressing leads to more pulp released with the juice. This provides a user selectable or tunable means of controlling pulp content.

As illustrated by diagram 320 in FIG. 31, more pulp can be extracted and expelled with the juice if the pressing action is performed at a higher speed. Specifically, the user can select a desired amount of pulp. In accordance with one exemplary feature, the full pressing motion can be over ˜100 mm, which is a little more than the size of a large orange.

The final part of the pressing motion is where the most juice is released from the orange. When the pressing of the orange takes place in ˜20 seconds or more, which is relatively slow, very little pulp is released with the juice. However, when the pressing is completed in ˜3 seconds, which is very fast, a lot more pulp is released with the juice, as illustrated by diagram 320.

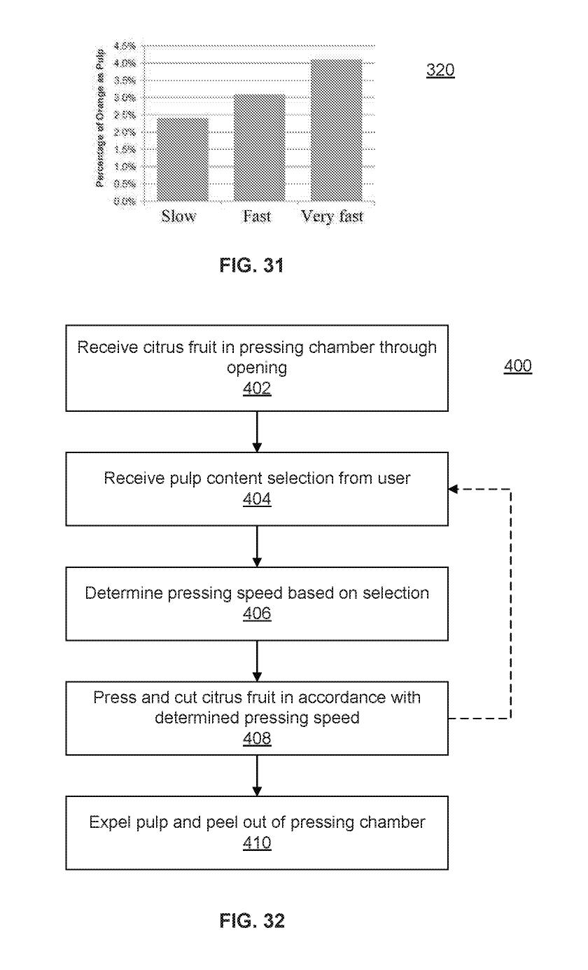

Referring now to FIG. 32, a method 400 for pressing juice from a citrus fruit is illustratively depicted. The method 400 can be implemented in any of the apparatus and devices described above and can be performed and/or directed by a hardware processor that executes a program of instructions stored on a transitory or non-transitory storage medium. The method 400 can begin at step 402, at which the citrus fruit is received through an opening to a pressing chamber. As discussed above, ends of the pressing chamber can be defined by surfaces of pressing elements. At step 404, a pulp content selection can be received from a user. For example, the user can enter a pulp content selection through a key pad or a touch screen on the device. In addition, the apparatus or device can provide the user with a plurality of options for varying degrees of pulp content, such as, for example, “low,” “medium” and “high.”

At step 406, the pressing speed of relative motion of the pressing elements can be determined based on the user-selection by referencing a function correlating pressing speeds to pulp content selections. For example, the function can be the chart values provided in diagram 320. Here, the pressing speeds increase with increasing pulp content.

At step 408, the citrus fruit can be pressed and cut by contacting different sides of the citrus fruit with surfaces of pressing elements, as discussed above. Further, the relative motion of the pressing elements is implemented at the pressing speed determined based on the pulp content selection.

Optionally, the method can proceed to step 404. Here, the user can change the pulp content selection midway through the pressing process and the user can receive a new content selection at step 404. In addition, the pressing device or apparatus can continue step 408 by adjusting the pressing speed of the relative motion of the pressing elements in accordance with the additional selection provided by the user.

At step 410, the pulp and a peel of the citrus fruit can be expelled out of the pressing chamber by rotating the chamber and enabling the pulp and the peel to fall out of the opening to the chamber due to gravity, as discussed above.

The exemplary embodiments described herein above provide a variety of features that can reduce the incidence of rupturing of oil pockets in a fruit peel during pressing. In particular, the embodiments can improve the taste of the juice pressed from the fruit by minimizing the amount of the oil in the juice, while at the same time providing an apparatus that is relatively easy to use and easy to clean.

It will be clear to a person skilled in the art that the scope of the present invention is not limited to the examples discussed in the foregoing, but that several amendments and modifications thereof are possible without deviating from the scope of the present invention as defined in the attached claims. While aspects of the present invention have been illustrated and described in detail in the figures and the description, such illustration and description are to be considered illustrative or exemplary only, and not restrictive. The present invention is not limited to the disclosed embodiments.

Variations to the disclosed embodiments can be understood and effected by a person of ordinary skill in the art in practicing the claimed invention, from a study of the figures, the description and the attached claims. In the claims, the word “comprising” does not exclude other steps or elements, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the present invention.

1. A citrus fruit pressing device, comprising:
two pressing elements for performing a pressing action on a citrus fruit, wherein said pressing elements have surfaces for contacting different sides of the citrus fruit and are movable toward and away from each other along an axis;
a pressing chamber a pressing housing, said pressing chamber is having an interior space for receiving the citrus fruit wherein the pressing chamber partially delimited by the surfaces of the pressing elements and wherein the surfaces constitute opposing ends of the pressing chamber; and
a cutting element disposed in the pressing chamber and configured to cut in a peel of the fruit, wherein the cutting element comprises a curved edge including a first edge portion that is within 45° of a line parallel to the axis and a second edge portion that is within 45° of a line perpendicular to said axis,
wherein the cutting element is configured to penetrate into a portion of the citrus fruit from an outer side of the citrus fruit which is free from contact to the surfaces of the pressing elements.

2. The citrus fruit pressing device of claim 1, wherein said first and second edge portions primarily compose said curved edge and wherein said first and second edge portions are straight edge portions that are disposed at an obtuse angle.

3. The citrus fruit pressing device of claim 1, wherein said first and second edge portions primarily compose said curved edge and wherein said first edge portion is a straight edge portion and said second edge portion is curved.

4. The citrus fruit pressing device of claim 1, wherein said first edge portion is disposed along an inner side surface of the pressing housing.

5. The citrus fruit pressing device of claim 1, wherein the outer side is a portion of the citrus fruit that expands in a sideward direction as a result of the pressing action.

6. A citrus fruit pressing device, comprising:
two pressing elements for performing a pressing action on a citrus fruit, wherein said pressing elements have surfaces for contacting different sides of the citrus fruit and are movable toward and away from each other;
a pressing chamber within a pressing housing, said pressing chamber having an interior space for receiving the citrus fruit, wherein the pressing chamber is partially delimited by the surfaces of the pressing elements and wherein the surfaces constitute opposing ends of the pressing chamber; and
at least two knives disposed in the pressing chamber that are configured to cut in a peel of the fruit and are separated by a separation space between the knives,
wherein the surface a first pressing element of said two pressing elements includes a protrusion that protrudes toward the interior space and includes a side that is delineated by a first side of a first knife of the at least two knives, said first side of said first knife opposing a second side of the first knife that delineates the separation space.

7. The pressing device of claim 6, wherein a first side of the protrusion matches a shape of said first knife, a second side of the protrusion matches a shape of said pressing housing and a third side of said protrusion is curved and matches a shape of the peel disposed outside of said separation space after the peel is cut.

8. The pressing device of claim 6, wherein said protrusion covers at least 75% of an area defined by a space between two cut edges of the peel.

9. The pressing device of claim 6, wherein said protrusion is a first protrusion, the surface of the first pressing element includes a second protrusion that protrudes toward the interior space and includes a side that is delineated by a first side of a second knife of the at least two knives, said first side of said second knife opposing a second side of the second knife that delineates the separation space.

10. The pressing device of claim 6, wherein said protrusion is a first protrusion, wherein the surface of a second pressing element of the two pressing elements includes a second protrusion that protrudes toward the interior space and includes a side that is delineated by the first side of said first knife.

11. A method for pressing juice from a citrus fruit comprising:
receiving the citrus fruit through an opening to a pressing chamber, wherein ends of said pressing chamber are defined by surfaces of pressing elements;
receiving a pulp content selection from a user;
pressing and cutting the citrus fruit by contacting different sides of the citrus fruit with said surfaces and implementing relative motion of the pressing elements at a pressing speed that is determined based on the pulp content selection; and
expelling pulp and a peel of the citrus fruit out of the pressing chamber by rotating the chamber and enabling the pulp and the peel to fall out of said opening due to gravity.

12. The method of claim 11, further comprising:
determining said pressing speed based on a function correlating pressing speeds to pulp content selections, wherein said pressing speeds increase with increasing pulp content.

13. The method of claim 11, further comprising:
receiving a second pulp content selection from a user; and
pressing and cutting the citrus fruit by adjusting the pressing speed of said relative motion.

14. The method of claim 13, wherein the second pulp content selection indicates an increased pulp content as compared to the first pulp content selection and wherein the pressing speed is increased in response to receiving the second pulp content selection.

15. The method of claim 13, wherein the second pulp content selection indicates a decreased pulp content as compared to the first pulp content selection and wherein the pressing speed is decreased in response to receiving the second pulp content selection.

16. Citrus fruit pressing device, comprising:
two pressing elements for performing a pressing action on a citrus fruit, wherein said pressing elements have surfaces for contacting different sides of the citrus fruit and are movable toward and away from each other;
a pressing chamber within a pressing housing, said pressing chamber having an interior space for receiving the citrus fruit, wherein the pressing chamber is partially delimited by the surfaces of the pressing elements and wherein the surfaces constitute opposing ends of the pressing chamber; and
a cutting element configured to form a cut into a peel of the citrus fruit at least partly along a circumference of the citrus fruit, wherein the device is configured to press the citrus fruit such that an outer surface of the citrus fruit is folded along said cut.

17. The citrus fruit pressing device of claim 16, wherein said cut is a hinged cut in that the depth of the cut penetrates less than a thickness of the peel.

18. The citrus fruit pressing device of claim 16, wherein said peel is folded at said cut.

19. The citrus fruit pressing device of claim 16, wherein the cutting element is configured to form the cut by removing at least part of the peel.

20. The citrus fruit pressing device of claim 16, wherein said cutting element is outside of said pressing chamber.

21. The citrus fruit pressing device of claim 20 further comprising:
gripping extensions on an outer surface of said pressing housing, wherein said pressing housing is configured to rotate to form said cut and wherein the gripping extensions are configured to grip and turn said citrus fruit as said cutting element cuts the citrus fruit.

22. The citrus fruit pressing device of claim 20, wherein said citrus fruit pressing device further includes flaps at an opening into the pressing chamber that are configured to reduce a velocity of said citrus fruit such that an orientation of said citrus fruit is essentially maintained when said citrus fruit is passed into said pressing chamber.

23. The citrus fruit pressing device of claim 16, wherein said cutting element is inside of said pressing chamber.

24. The citrus fruit pressing device of claim 23, wherein said device implements said cut by oscillating, rotational motion of said pressing housing.

25. The citrus fruit pressing device of claim 23, further comprising:
a rotatable member within said pressing housing, wherein said rotatable member is configured to rotate said citrus fruit to implement said cut.

26. The citrus fruit pressing device of claim 23, wherein said cutting element is a first cutting element, wherein said cut is a first cut and wherein said device further comprises:
at least one second cutting element configured to implement at least one second cut that is a primary means by which juice is pressed out of said citrus fruit, wherein said first cutting element is disposed between said at least one second cutting element and one of said surfaces of said pressing elements such that said first cut is implemented after said second cut when said citrus fruit is moved between said pressing elements.

27. A method for pressing juice from a citrus fruit comprising:
receiving the citrus fruit through an opening to a pressing chamber, wherein ends of said pressing chamber are defined by surfaces of pressing elements;
forming a cut by cutting into a peel of the citrus fruit at least partly along a circumference of the citrus fruit; and
pressing the citrus fruit by contacting different sides of the citrus fruit with said surfaces such that an outer surface of the citrus fruit is folded along said cut.
